(19) United States
(12) Patent Application Publication
(10) Pub. No.: US 2012/0172238 A1
(43) Pub. Date: Jul. 5, 2012

(54) METHOD AND COMPOSITIONS FOR ASSISTING IN DIAGNOSING AND/OR MONITORING BREAST CANCER PROGRESSION

(75) Inventors: Vinay Varadan, New York, NY (US); Sitharthan Kamalakaran, Pelham, NY (US); James Bruce Hicks, Lattingtown, NY (US)

(73) Assignees: COLD SPRING HARBOR LABORATORIES, COLD SPRING HARBOR, NY (US); KONINKLIJKE PHILIPS ELECTRONICS N.V., EINDHOVEN (NL)

(21) Appl. No.: 13/497,062

(22) PCT Filed: Sep. 15, 2010
(86) PCT No.: PCT/IB10/54152

§ 371 Date: Mar. 20, 2012

Related U.S. Application Data
(60) Provisional application No. 61/244,625, filed on Sep. 22, 2009.

(51) Int. Cl. C40B 20/00; C40B 40/06

(52) U.S. Cl. 506/2; 506/16

(57) ABSTRACT

The present invention relates to a method for assisting in diagnosing breast cancer and/or monitoring breast cancer progression in a given sample based on the analysis of differential DNA methylation patterns. More particularly, the method is directed to the identification of one or more epigenetic markers that derive from the application of a variety of statistical methods in order to point out the prognostic significance of the difference in methylation states at one or more genomic loci and predict whether the sample analyzed has a good or bad prognosis following treatment.

### FIELD OF THE INVENTION

The present invention relates to a method for assisting in diagnosing breast cancer and/or monitoring breast cancer progression in a given sample based on the analysis of differential DNA methylation patterns. More particularly, the method is directed to the identification of one or more epigenetic markers that derive from the application of a variety of statistical methods in order to point out the prognostic significance of the difference in methylation states at one or more genomic loci and predict whether the sample analyzed has a good or bad prognosis following treatment.

### BACKGROUND OF THE INVENTION

DNA methylation is found in the genomes of diverse organisms including both prokaryotes and eukaryotes. In prokaryotes, DNA methylation occurs on both cytosine and adenine bases and encompasses part of the host restriction system. In multicellular eukaryotes, however, methylation seems to be confined to cytosine bases and is associated with a repressed chromatin state and inhibition of gene expression (reviewed, for example, in Wilson, G. G. and Murray, N. E. (1991) Annu. Rev. Genet. 25, 585-627).

In mammalian cells, DNA methylation predominantly occurs at CpG dinucleotides, which are distributed unevenly and are underrepresented in the genome. Clusters of usually unmethylated CpGs (also referred to as CpG islands) are found in many promoter regions (reviewed, e.g., in Li, E. (2002) Nat. Rev. Genet. 3, 662-673). Changes in DNA methylation leading to aberrant gene silencing have been demonstrated in several human cancers such as colorectal and prostate cancer (reviewed, e.g., in Robertson, K. D. and Wolffe, A. P. (2000) Nat. Rev. Genet. 1, 11-19). Hypermethylation of promoters was demonstrated to be a frequent mechanism leading to the inactivation of tumor suppressor genes. In the other hand, promoter hypomethylation often correlates to DNA breaks and genome instability, and thus to the severity of some cancers (Bird, A. P. (2002) Genes Dev. 16, 6-21).

Various methods exist for experimentally determining differential methylation in individual genes (reviewed, e.g., in Rein, T. et al. (1998) Nucleic Acids Res. 26, 2255-2264). These techniques include inter alia bisulfite sequencing, methylation specific PCR (MSP), Methylight and pyro-sequencing.

Breast cancer affects 1.2 million people worldwide and is one of the leading causes of death in women, with approximately 400,000 new cases being diagnosed in the USA and Western Europe each year. Therefore, breast cancer diagnostics remains a high opportunity market.

Differential methylation patterns of several target genes has been associated with the outcome of breast cancer (see, e.g., Zrihan-Licht, S. et al. (1995) Int. J. Cancer 62, 245-251; Mancini, D. N. et al. (1998) Oncogene 16, 1161-1169). However, many different clinical types of breast cancer exist, some of which are not well characterized on a molecular level at all. Furthermore, available diagnostic assays for analyzing breast cancer are also hampered by the fact that they are typically based on the analysis of only a single molecular marker, which might affect reliability and/or accuracy of detection. In addition, a single marker normally does not enable detailed predictions concerning latency stages, tumor progression, and the like.

Thus, there is still a need for the identification of alternative molecular markers and assay formats for assisting in diagnosing breast cancer and/or monitoring breast cancer progression overcoming these limitations. The most useful biomarkers from a clinical standpoint are predictive markers that can predict the response to any treatment regiment at the time of diagnosis. Prognostic markers that can identify a patient's risk of relapse with breast cancer after surgery are also useful, especially if they can identify patients who are at low risk for relapse and thus can be exempted from highly toxic chemotherapy.

### SUMMARY OF THE INVENTION

It is an objective of the present invention to provide novel approaches for assisting in diagnosing breast cancer and/or monitoring breast cancer progression based on the analysis of differential DNA methylation patterns.

More specifically, it is an objective to provide panels of epigenetic markers that derive from the application of a variety of statistical methods in order to point out the significance of the difference in methylation states at one or more genomic loci analyzed, thus enabling the prediction whether a given sample is predicted to have good or bad prognosis following treatment.

Furthermore, it is an objective to provide a diagnostic approach enabling a reliable and accurate breast cancer prognosis independent of other pathological parameters than the methylation state.

These objectives as well as others, which will become apparent from the ensuing description, are attained by the subject matter of the independent claims. Some of the preferred embodiments of the present invention are defined by the subject matter of the dependent claims.

In one aspect, the present invention relates to a method for assisting in diagnosing breast cancer and/or monitoring breast cancer progression, comprising:
(a) determining the methylation state at one or more genomic loci of the DNA comprised in a given sample to be analyzed;
(b) identifying one or more genomic loci exhibiting differences in its/their DNA methylation state;
(c) performing a statistical survival analysis for each of the one or more differentially methylated genomic loci obtained in step (b);
(d) determining the statistical significance of the data obtained in step (c); and
(e) selecting one or more genomic loci displaying statistically significant differences in its/their DNA methylation state based on the data obtained in step (d), wherein the one or more genomic loci selected have prognostic value for assisting in diagnosing breast cancer and/or monitoring breast cancer progression.

In a specific embodiment of the method, the breast cancer is estrogen receptor positive breast cancer.

In a preferred embodiment, the method is used for assisting in diagnosing breast cancer and/or monitoring breast cancer progression in a patient, and further comprises:

providing a genomic DNA sample from the patient to be analyzed,

wherein the method is performed in vitro.

In another specific embodiment, the method further comprises:

classifying the one or more genomic loci according to its/their methylation state as unmethylated, partially methylated, and methylated prior to performing step (c).

In a preferred embodiment, the statistical survival analysis performed in step (c) comprises generating Kaplan-Meier survival estimates for the respective methylation states (that is, the samples belonging to the respective methylation state) of each of the one or more genomic loci and calculating the differences between the Kaplan-Meier survival estimates generated for each of the loci.

In a further preferred embodiment, determining the statistical significance of the data obtained in the survival analysis comprises applying the log-rank or Mantel-Haenszel test. Particularly preferably, determining the statistical significance further comprises a permutation testing method.

In another specific embodiment, the method further comprises:

determining whether the prognostic value of the one or more genetic loci selected is independent of other pathological parameters than the methylation state.

Particularly preferably, the method is performed using a computing device.

In another aspect, the present invention relates to a panel of genetic markers for assisting in diagnosing breast cancer and/or monitoring breast cancer progression in a patient, wherein the panel comprises any one or more, or preferably all, of the genetic markers listed in Table 1.

In yet another aspect, the present invention relates to a panel of genetic markers for assisting in diagnosing estrogen receptor positive breast cancer and/or monitoring estrogen receptor positive breast cancer progression in a patient, wherein the panel comprises any one or more, or preferably all, of the genetic markers listed in Table 2.

Preferably, the panels of genetic markers are determined by the method as defined herein.

In a further aspect, the present invention relates to the use of the panels of genetic markers as defined herein for assisting in diagnosing breast cancer and/or monitoring breast cancer progression in a patient.

In a preferred embodiment, the monitoring of breast cancer progression comprises stratification of breast cancer patients into good or poor prognosis groups. Particularly preferably, the monitoring of breast cancer progression comprises predicting relapse free survival at five years from diagnosis.

### BRIEF DESCRIPTION OF THE DRAWINGS

FIG. 1 schematically depicts the procedure for designing the Methylation Oligonucleotide Microarray Analysis (MOMA) array used in the present invention for performing whole genome detection of differentially methylated loci. In brief, the genomic DNA is digested with a restriction endonuclease with a CG rich recognition sequence (MspI), followed by ligation of adaptors for use in a subsequent step of reducing genomic complexity. One-half of the adaptor-ligated sample is depleted of its methylated sequences by digestion with the methylation specific endonuclease, McrBC, and the other half is mock-treated. Carefully balanced PCR conditions are used to size-select MspI fragments and reduce the overall genome complexity. The McrBC treated representation is compared to the mock treated sample which serves as the reference for comparative hybridization on an oligonucleotide tiling array with 367K features with coverage of 26.219 out of 27.801 annotated CpG islands.

FIG. 2 represents a schematic illustration of the method according to the present invention for identifying prognostic differentially methylated genomic loci being indicative for assisting in diagnosing breast cancer and/or monitoring breast cancer progression in a given sample. Upon identification of one or more genomic loci displaying differences in its/their methylation behavior (not shown) the significance of the variation in methylation status at each locus is evaluated using a statistical survival model involving the generation of Kaplan-Meier estimators for the three methylation states unmethylated, partially methylated, and methylated, respectively. In case, the difference between the Kaplan-Meier estimators obtained for a particular locus is statistically significant, this locus is retained for further analysis. Otherwise, it is discarded.

FIG. 3 schematically depicts a general procedure according to the present invention for analyzing the statistical significance of the prognostic genomic loci identified in a given sample. Statistically significant differences in the three Kaplan-Meier estimates are determined by using the log-rank or Mantel-Haenszel test resulting in a chi-square value for each comparison. The statistical significance of these differences can be estimated through a permutation testing method, which involves permuting the clinical data and recomputing the chi-square index for all loci. This is repeated 1000 times to obtain a background distribution of chi-square values. Then, the chi-square value for each locus obtained from the original clinical data is compared to the background distribution and any locus that achieves a statistical significance of 0.05 or lower, after Benjamini-Hochberg multiple testing correction, is potentially a good biomarker for stratification of patients into good and poor prognosis groups.

### DETAILED DESCRIPTION

The present invention is based on the unexpected finding that combining analysis of differential DNA methylation in a sample with a variety of statistical and machine learning methods in order to point out the significance of the difference in methylation states results in the identification of panels of epigenetic markers having independent prognostic value for assisting in diagnosing and/or monitoring the progression of breast cancer.

The present invention illustratively described in the following may suitably be practiced in the absence of any element or elements, limitation or limitations, not specifically disclosed herein.

The present invention will be described with respect to particular embodiments and with reference to certain drawings but the invention is not limited thereto but only by the claims. The drawings described are only schematic and are to be considered non-limiting.

Where the term “comprising” is used in the present description and claims, it does not exclude other elements or steps. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Where an indefinite or definite article is used when referring to a singular noun e.g. “a” or “an”, “the”, this includes a plural of that noun unless something else is specifically stated.

The term “about” in the context of the present invention denotes an interval of accuracy that the person skilled in the art will understand to still ensure the technical effect of the feature in question. The term typically indicates deviation from the indicated numerical value off 10%, and preferably ±5%.

Furthermore, the terms first, second, third, (a), (b), (c), and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Further definitions of term will be given in the following in the context of which the terms are used.

The following terms or definitions are provided solely to aid in the understanding of the invention. These definitions should not be construed to have a scope less than understood by a person of ordinary skill in the art.

In one aspect, the present invention relates to a method for assisting in diagnosing breast cancer and/or monitoring breast cancer progression, comprising:
(a) determining the methylation state at one or more genomic loci of the DNA comprised in a given sample to be analyzed;
(b) identifying one or more genomic loci exhibiting differences in its/their DNA methylation state;
(c) performing a statistical survival analysis for each of the one or more differentially methylated genomic loci obtained in step (b);
(d) determining the statistical significance of the data obtained in step (c); and
(e) selecting one or more genomic loci displaying statistically significant differences in its/their DNA methylation state based on the data obtained in step (d), wherein the one or more genomic loci selected have prognostic value for assisting in diagnosing breast cancer and/or monitoring breast cancer progression.

The term “cancer”, as used herein, generally denotes any type of malignant neoplasm, that is, any morphological and/or physiological alterations (based on genetic re-programming) of target cells exhibiting or having a predisposition to develop characteristics of a carcinoma as compared to unaffected (healthy) wild-type control cells. Examples of such alterations may relate inter alia to cell size and shape (enlargement or reduction), cell proliferation (increase in cell number), cell differentiation (change in physiological state), apoptosis (programmed cell death) or cell survival. Hence, the term “breast cancer” refers to cancerous growths in breast tissue.

In one embodiment of the method according to the present invention, the breast cancer is estrogen receptor positive breast cancer.

In a preferred embodiment, the method is used for assisting in diagnosing breast cancer and/or monitoring breast cancer progression in a patient, and further comprises:
providing a genomic DNA sample from the patient to be analyzed, wherein the method is performed in vitro.

The term “in vitro”, as used herein, denotes that the method is performed using an isolated DNA sample derived from the patient to be analyzed, that is, one or more cells, a cell extract, a tissue biopsy, and the like.

The term “sample” (or “genomic sample”), as used herein, denotes any sample comprising one or more genomic DNA molecules whose differential methylation status is to be analyzed. The DNA molecules comprised in the sample may be naturally occurring or synthetic compounds (e.g., generated by means of recombinant DNA technology or by chemical synthesis) and may be single-stranded or double-stranded. The DNA molecules may have any length. Typically, the length varies between 10 bp and 100000 bp, preferably between 100 bp and 10000 bp, and particularly preferably between 500 bp and 5000 bp.

The DNA molecules comprised in the sample may be present in purified form (e.g., provided in a suitable buffer solution such as TE or PBS known in the art) or may be included in an unpurified, partially purified or enriched sample solution. Examples of such unpurified samples include cell lysates, body fluids (e.g., blood, serum, salvia, and urine), solubilized tissues, and the like.

In some embodiments, the method according to the present invention also comprises the purification of the DNA present in such an unpurified sample. Methods and corresponding devices for purifying DNA (optionally as integral part of an automated system or working platform) are well known in the art and commercially available from many suppliers.

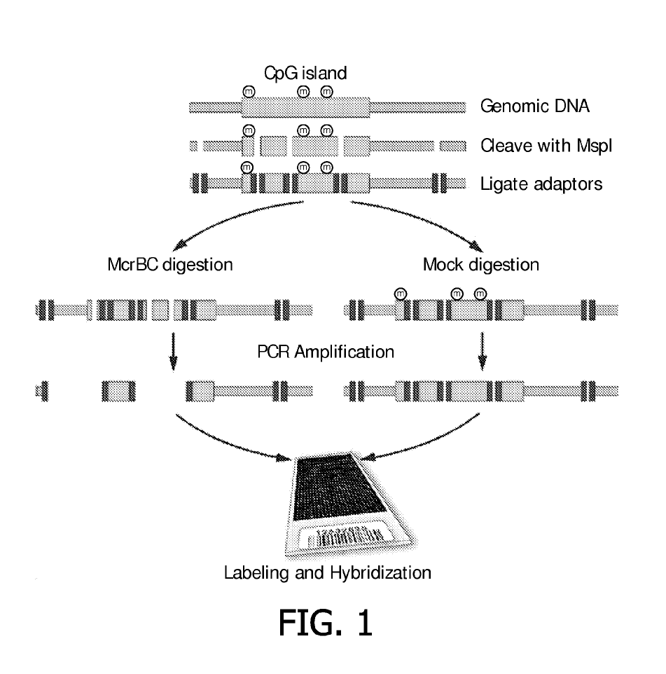

The determination of the methylation state of the DNA comprised in the sample may be performed using any detection method established in the art, e.g., including bisulfite-sequencing, methylation-sensitive single-strand conformation analysis (MS-SSCA), methylation-sensitive single nucleotide primer extension (MS-SnuPE), methylation-sensitive microarray applications, combined bisulfite restriction analysis (COBRA), methlyation-sensitive real-time PCR applications, and the like. In preferred embodiments, the analysis of the DNA methylation patterns is performed in a whole genome format using Methylation Oligonucleotide Microarray Analysis (MOMA) arrays (cf. also FIG. 1).

Within the present invention, each methylation profile was determined by using an expectation maximization algorithm to pool each genomic locus in a particular sample into one of three distinct methylation states—unmethylated, partially methylated and methylated.

Subsequently, the method of the invention comprises the identification of one or more genomic loci are exhibiting differences in its/their DNA methylation state, that is, genomic loci which are, for example, unmethylated in non-tumor samples and become (at least partially) methylated during tumor progression, or vice versa, which are (at least partially) methylated in non-tumor samples and become demethylated during tumor progression.

In some embodiments, the results of the differential methylation analyses are compared with a reference value, for example the methylation pattern obtained using a DNA sample derived from a healthy subject or with data from the literature in order to identify differential methylation.

In specific embodiments, the one or more differentially methylated genomic loci are classified according to its/their methylation state as unmethylated, partially methylated, and methylated prior to performing the statistical survival analysis.

In the next step, the methylation data obtained are subjected to a statistical survival analysis in order to identify whether a methylation state of a particular genomic locus in the breast tumor sample would classify the patient as having good or bad prognosis, that is, whether the variation in methylation behavior observed is significant. Several statistical survival models are known in the art. The method of present invention may be practiced by employing any of these models.

Preferably, however, the statistical survival analysis performed in step (c) of the method according to the invention comprises generating Kaplan-Meier survival estimates for the respective methylation states (that is, for the samples belonging to the respective methylation states) of each of the one or more genomic loci and calculating the differences between the Kaplan-Meier survival estimates generated for each of the loci (that is, for the samples belonging to each of the loci).

The Kaplan-Meier estimator of the survival function is known in the art (Hosmer, D. W., et al. (2008) Applied Survival Analysis—Regression Modeling of Time-to-Event Data. 2nd ed. Wiley Series in Probability and Statistics. Hoboken, N.J.: John Wiley & Sons, Inc.) and calculates the probability of no systemic recurrence at a given time by using the time to systemic recurrence for all the patients included in the study. Since some patients typically leave the study after a while, the Kaplan-Meier estimator accounts for the loss of patients from the study at different points in time due to lack of follow-up. This is called the “censoring problem” in survival analysis and is already accounted for in the Kaplan-Meier estimator. Within the present invention, the probability of no systemic recurrence was calculated over a period of 10 years after initial diagnosis. However, other periods of time (e.g., 1, 3, 5, 15 or 20 years) are possible as well.

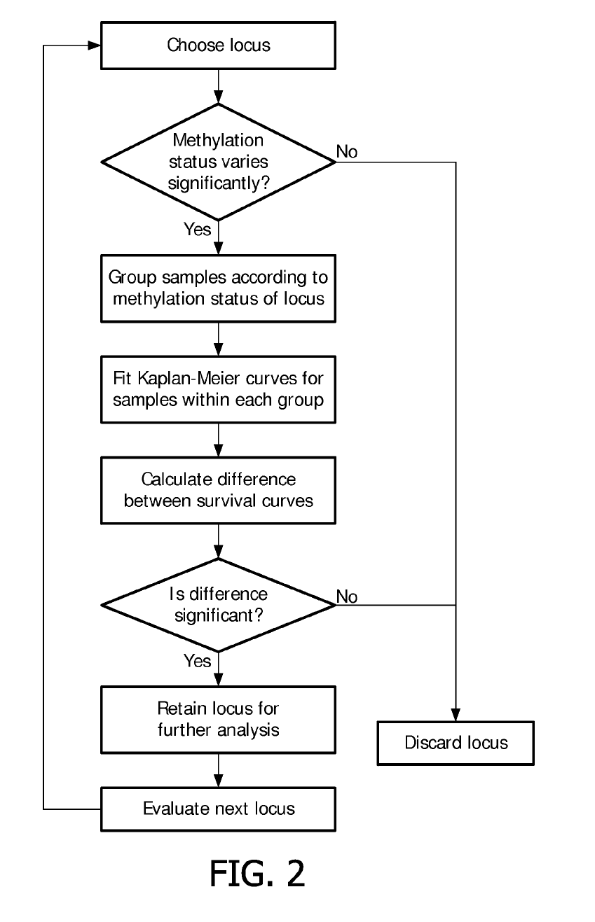

Kaplan-Meier estimators are generated for the three methylation states unmethylated, partially methylated, and methylated, respectively. In case, the difference between the Kaplan-Meier estimators obtained for a particular locus is significant, this locus is retained for further analysis. Otherwise, it is discarded. The overall procedure for performing the statistical survival analysis is schematically depicted in FIG. 2.

In order to select those genomic loci whose differential methylation pattern has independent prognostic value for breast cancer diagnosis, as a next step, the statistical significance of the data obtained in the survival analysis is determined. Again, various established statistical means are possible for performing such tests. The skilled person is well aware of how to select an appropriate procedure.

In a preferred embodiment of the method, determining the statistical significance of the data obtained in the survival analysis comprises applying the log-rank or Mantel-Haenszel test, which is established in the art as well (Hosmer, D. W., et al. (2008), supra). This test outputs a chi-square value for each comparison, which is a measure of the amount of difference in the Kaplan-Meier curves. The statistical significance of these differences can be further validated through a permutation testing method, which, for example, involves permuting the available clinical data of the samples analyzed and recomputing the chi-square index for all loci.

Thus, in a further preferred embodiment of the method, determining the statistical significance of the data obtained in the survival analysis further comprises a permutation testing method. This is repeated several times (e.g., 2, 5, 10, 50, 100, 200, 500, 1000, 2000 times, and so forth) to obtain a background distribution of chi-square values for all loci. Within the present invention, the permutation testing method is preferably repeated 1000 times.

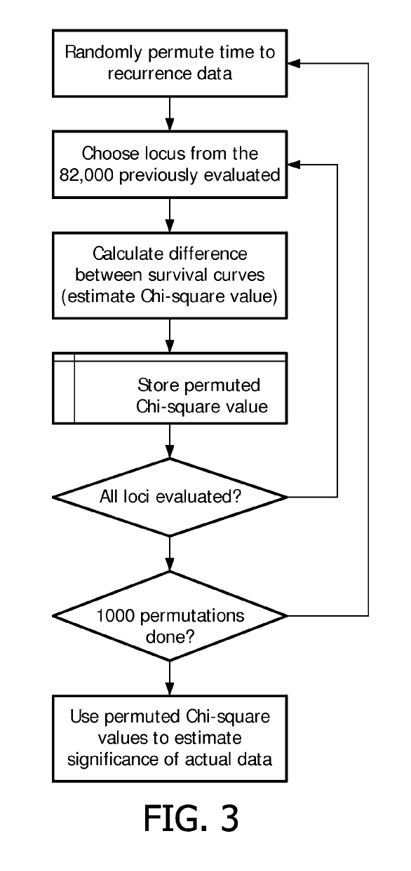

Then, the chi-square value for each genomic locus obtained from the original clinical data is compared to the background distribution. Any locus that achieves a statistical significance of 0.05 or lower after multiple testing correction, for example after Benjamini-Hochberg correction (Benjamini, Y. and Hochberg, Y. (1995) J. Royal Stat. Soc. Series B 57, 289-300), is considered a good biomarker for stratification of patients into good and poor prognosis groups. The overall procedure for performing the analysis of statistical significance is schematically depicted in FIG. 3.

Finally, in some embodiments, the method of the present invention comprises determining whether the prognostic value of the one or more genetic loci selected is independent of other pathological parameters than the methylation state, that is, the results obtained are corrected for any ambiguities potentially associated with clinical parameters such as age of the patients analyzed, tumor grade, adjuvant or hormone therapy, and the like.

In order to estimate the extent to which the cancer recurrence rates were correlated with the methylation status of a given locus established Cox regression analysis may be used but other models are possible as well. Loci that had a statistically significant Cox coefficient (as determined by the Wald test) were chosen for further analysis. Multivariate Cox regression may be performed using the methylation status of the significant loci in combination with, for example, age (e.g. <55 versus >55), tumor grade (I or II versus III), as well as the status of several marker proteins such as p53 (positive versus negative), estrogen receptor (ER) (positive versus negative) and ERBB2 (positive versus negative).

Loci that had statistically significant Cox coefficient in the multivariate Cox regression model were considered to be providing prognostic information independent of the other clinical factors for assisting in diagnosing breast cancer and/or monitoring breast cancer progression.

Particularly preferably, the method according to the present invention is performed using a computing device. Such devices are known in the art and may be configured in many ways. For example, such computing device may be designed to receive a data set concerning the DNA methylation status of one or more genomic loci of the DNA comprised in a given sample, processing this dataset to identify one or more genomic loci exhibiting differences in its/their DNA methylation state, subjecting the differentially methylated one or more genomic loci identified to the statistical survival analysis using an appropriate algorithm, correlating the data set obtained with other clinical parameters associated with the sample tested, and generating a (ranked) listing based of the correlated data of one or more genomic loci displaying statistically significant independent prognostic value for assisting in diagnosing breast cancer and/or monitoring breast cancer progression.

In another aspect, the present invention relates to a panel of genetic (more particularly epigenetic) markers for assisting in diagnosing breast cancer and/or monitoring breast cancer progression in a patient, wherein the panel comprises any one or more, or preferably all, of the 241 genetic markers listed in Table 1. All these markers are based on differential DNA methylation patterns.

In yet another aspect, the present invention relates to a panel of genetic (more particularly epigenetic) markers for assisting in diagnosing estrogen receptor positive breast cancer and/or monitoring estrogen receptor positive breast cancer progression in a patient, wherein the panel comprises any one or more, or preferably all, of the 105 genetic markers listed in Table 2. All these markers are based on differential DNA methylation patterns.

Preferably, the above-referenced panels of genetic markers are determined by the method as defined herein.

The term “any one or more”, as used herein, relates to any one or any subgroup of any two or more (i.e. any two, any three, any four, any five, any six, any seven, any eight, any nine, any ten, and so forth) or to all of the respective genetic marker genes disclosed herein in Tables 1 and 2, respectively.

Preferably, the panel of epigenetic markers for assisting in diagnosing breast cancer comprises all of the 241 markers listed in Table 1, whereas the panel of epigenetic markers for assisting in diagnosing estrogen receptor positive breast cancer comprises all of the 105 markers listed in Table 2.

The markers listed in Tables 1 and 2 are unambiguously defined by means of their chromosomal location (i.e. number of the human chromosome as well as start and end points of the respective chromosomal fragment).

In a further aspect, the present invention relates to the use of the panels of genetic markers as defined herein for assisting in diagnosing breast cancer and/or monitoring breast cancer progression in a patient. The panels of genetic markers may also be used to classify breast cancer patients according to tumor type or tumor grade.

In a preferred embodiment, the monitoring of breast cancer progression comprises stratification of breast cancer patients into good or poor prognosis groups (for example, based on the respective p-values associated with the statistical multivariate model described herein; cf. also Tables 1 and 2). Particularly preferably, the monitoring of breast cancer progression comprises predicting relapse free survival at five (or, e.g., 10) years from diagnosis.

The invention is further described by the figures and the following examples, which are solely for the purpose of illustrating specific embodiments of this invention, and are not to be construed as limiting the scope of the invention in any way.

### EXAMPLES

### Example 1

### Design of a DNA Array for Performing Differential Methylation Analysis

The Methylation Oligonucleotide Microarray Analysis (MOMA) array used in the present invention for performing whole genome detection of differentially methylated loci was designed as follows.

The genomic DNA was digested with a restriction endonuclease with a CG rich recognition sequence (MspI), followed by ligation of adaptors for use in a subsequent step of reducing genomic complexity. One-half of the adaptor-ligated sample was depleted of its methylated sequences by digestion with the methylation specific endonuclease, McrBC, and the other half was mock-treated. Carefully balanced PCR conditions were used to size-select Mspl fragments and reduce the overall genome complexity. The McrBC treated representation was compared to the mock treated sample which serves as the reference for comparative hybridization on an oligonucleotide tiling array with 367K features with coverage of 26.219 out of 27.801 annotated CpG islands. The procedure is schematically illustrated in FIG. 1.

### Example 2

### Breast Cancer Samples

DNA methylation analysis was performed for 121 human breast tumors, 108 of which had associated clinic-pathological annotations including relapse and survival data for up to 10 years.

In one embodiment, only those tumors that were Estrogen receptor positive were analyzed, a total of 70 tumors.

Each sample's methylation profile was determined by using an expectation maximization algorithm to pool each locus into one of three distinct states—unmethylated, partially methylated and methylated.

Gnomic DNA extraction from the tumor samples as well as determining the DNA methylation pattern was performed according to established standard proceedings.

### Example 3

### Statistical Survival Model

The statistical model chosen for evaluating the probability that there would be no systemic recurrence in a given amount of time is the Kaplan-Meier estimator of the survival function.

The Kaplan-Meier estimator calculates the probability of no systemic recurrence at a given time by using the time to systemic recurrence for all the patients included in the study. Since some patients typically leave the study after a while, the Kaplan-Meier estimator accounts for the loss of patients from the study at different points in time due to lack of follow-up. This is called the “censoring problem” in survival analysis and is already accounted for in the Kaplan-Meier estimator. The Kaplan-Meier estimator was used to analyze the probability of no systemic recurrence over a period of 10 years after initial diagnosis. The procedure for identifying genomic loci that have potential prognostic value for diagnosing and/or monitoring breast cancer is schematically given in FIG. 2.

### Example 4

### Identification of Genomic Loci Having Independent Prognostic Value

Using the above methodology, 159.436 genomic loci in the dataset were searched for loci with prognostic capability.

Given the three possible states of any locus (i.e. unmethylated, partially methylated, and methylated), the Kaplan-Meier estimator is used to estimate the probability of no systemic recurrence for at least 10 years using all the patients that fall into a given methylation state of the locus.

Statistically significant differences in the three Kaplan-Meier estimates were evaluated by using the log-rank or Mantel-Haenszel test. This test results in a chi-square value for each comparison, which is a measure of the amount of difference in the Kaplan-Meier curves. The statistical significance of these differences can be estimated through a permutation testing method, which involves permuting the clinical data and recomputing the chi-square index for all loci. This was repeated 1000 times to obtain a background distribution of chi-square values. Then the chi-square value for each locus obtained from the original clinical data was compared to the background distribution. Any locus achieving a statistical significance of 0.05 or lower, after Benjamini-Hochberg multiple testing correction, is considered to represent a suitable biomarker for stratification of patients into good and poor prognosis groups. This procedure is also schematically outlined in FIG. 3.

In one experiment, all 121 breast tumors were included in the analysis. Based on the methodology described above, the number of potential prognostic genomic loci was narrowed to 2.559.

Then, it was determined whether these loci were providing prognostic information independent of other clinical variables such as ER/PR status, ERBB2 status, tumor grade, as well as adjuvant or hormone therapy.

Cox regression analysis was used to estimate the extent to which the cancer recurrence rates were correlated with the methylation status of a given locus. Loci that had a statistically significant Cox coefficient (as determined by the Wald test) were chosen for further analysis. Multivariate Cox regression was performed using the methylation status of the significant loci in combination with age (<55 versus >55), tumor grade (I or II versus III), p53 status (positive versus negative), ER status (positive versus negative), and ERBB2 status (positive versus negative). Loci that had statistically significant Cox coefficient in the multivariate Cox regression model were considered to be providing prognostic information independent of the other clinical factors.

Finally, a total of 241 loci that had prognostic value independent of other clinical factors could be identified. These loci (unambiguously characterized by their chromosomal position) are included in Table 1.

In another experiment, only the 70 estrogen receptor positive breast cancer samples were included in the analysis.

After eliminating all loci that did not provide prognostic information independent of the other clinical factors, a total of 105 loci could be identified as independent prognostic factors for estrogen receptor positive tumors. These loci are listed in Table 2.

The present invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by embodiments and optional features, modifications and variations of the inventions embodied therein may be resorted to by those skilled in the art, and that such modifications and variations are considered to be within the scope of this invention.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims. In addition, where features or aspects of the invention are described in terms of Markush groups, those skilled in the art will recognize that the invention is also thereby described in terms of any individual member or subgroup of members of the Markush group.

TABLE 1
Differentially methylated independent genomic loci having prognostic value for
assisting in diagnosing and/or monitoring breast cancer progression.

| | | | | | | SurvDiff |
|---|---|---|---|---|---|---|
| MspFragID | ChrNo. | FragStart | FragEnd | Fragcoef | HR | pval |
| MspFrag12449 | 1 | 220928782 | 220928852 | −1.615094853 | 5.028364856 | 7.28E−07 |
| MspFrag157734 | 23 | 134955435 | 134955489 | 1.565184727 | 4.783558505 | 1.39E−06 |
| MspFrag151940 | 22 | 40800390 | 40800450 | −1.621278128 | 5.059552944 | 3.13E−06 |
| MspFrag105924 | 15 | 38550795 | 38550931 | 1.49000739 | 4.437128311 | 5.40E−06 |
| MspFrag22802 | 2 | 219674601 | 219674653 | 1.517366661 | 4.560200815 | 7.63E−06 |
| MspFrag90914 | 12 | 21986230 | 21986315 | −1.452721602 | 4.274732819 | 8.41E−06 |
| MspFrag144132 | 20 | 30635304 | 30635374 | 1.566147711 | 4.788167217 | 1.01E−05 |
| MspFrag148589 | 21 | 44583759 | 44585693 | 1.496010703 | 4.463845896 | 1.05E−05 |
| MspFrag75113 | 10 | 12431830 | 12431927 | −1.416000981 | 4.120609054 | 1.29E−05 |
| MspFrag36468 | 4 | 147040269 | 147040359 | 1.450995442 | 4.267360311 | 1.40E−05 |
| MspFrag145054 | 20 | 43874589 | 43874738 | −1.376794031 | 3.962178623 | 1.59E−05 |
| MspFrag155417 | 23 | 47274997 | 47276608 | 1.352266033 | 3.866176496 | 1.92E−05 |
| MspFrag38306 | 5 | 1062804 | 1063000 | 1.395635503 | 4.037539625 | 2.01E−05 |
| MspFrag8611 | 1 | 113645376 | 113645473 | −1.364341616 | 3.913145852 | 2.09E−05 |
| MspFrag10298 | 1 | 157045379 | 157045911 | −1.527883737 | 4.608413881 | 2.36E−05 |
| MspFrag144777 | 20 | 39091433 | 39091534 | −1.33969932 | 3.817895368 | 2.73E−05 |
| MspFrag131356 | 19 | 786908 | 787770 | 1.496416804 | 4.465659036 | 2.75E−05 |
| MspFrag3468 | 1 | 21855222 | 21855381 | −1.380342674 | 3.976263955 | 3.46E−05 |
| MspFrag56306 | 7 | 72171559 | 72171806 | 1.321298164 | 3.748284109 | 3.80E−05 |
| MspFrag141448 | 19 | 60572535 | 60572583 | 1.358235368 | 3.889324017 | 4.49E−05 |
| MspFrag44952 | 5 | 179207859 | 179211165 | 1.30777058 | 3.697920297 | 4.53E−05 |
| MspFrag109776 | 15 | 99147210 | 99147469 | 1.408502929 | 4.089828056 | 4.65E−05 |
| MspFrag74125 | 9 | 137524288 | 137524337 | 1.419924397 | 4.136807674 | 4.78E−05 |
| MspFrag1715 | 1 | 6193604 | 6193659 | 2.363752124 | 10.63076466 | 5.28E−05 |
| MspFrag26474 | 3 | 48463194 | 48463299 | −1.363627751 | 3.910353389 | 5.83E−05 |
| MspFrag336 | 1 | 1064313 | 1064455 | 1.33576641 | 3.802909418 | 6.04E−05 |
| MspFrag26271 | 3 | 46593412 | 46593530 | 1.399387272 | 4.052715993 | 6.38E−05 |
| MspFrag131504 | 19 | 947075 | 947164 | 1.319835802 | 3.742806765 | 6.51E−05 |
| MspFrag89957 | 12 | 1610022 | 1610074 | 1.293465083 | 3.645396297 | 6.69E−05 |
| MspFrag69663 | 9 | 86993066 | 86993159 | −1.38706377 | 4.003078821 | 6.75E−05 |
| MspFrag148520 | 21 | 44377738 | 44377787 | 1.534888678 | 4.640808876 | 6.93E−05 |
| MspFrag32887 | 4 | 6682668 | 6682802 | 1.287212785 | 3.622675295 | 7.03E−05 |
| MspFrag26260 | 3 | 46012237 | 46012342 | −1.264209077 | 3.540291531 | 7.28E−05 |
| MspFrag20166 | 2 | 128359264 | 128359351 | −1.305743845 | 3.690433182 | 7.28E−05 |
| MspFrag66968 | 8 | 145669475 | 145670977 | 1.310061875 | 3.70640304 | 7.91E−05 |
| MspFrag117001 | 16 | 86300161 | 86300339 | 1.81259069 | 6.126298231 | 0.00010052 |
| MspFrag67675 | 9 | 6748739 | 6748894 | −1.310732835 | 3.708890721 | 0.00010154 |
| MspFrag89277 | 11 | 124175412 | 124175513 | −1.449554199 | 4.261214436 | 0.000104 |
| MspFrag41501 | 5 | 108773228 | 108773292 | 1.501362626 | 4.487800098 | 0.00010676 |
| MspFrag10351 | 1 | 157985104 | 157985213 | −2.862718394 | 17.509058830 | 0.00010764 |
| MspFrag89167 | 11 | 122437800 | 122437852 | 1.303240178 | 3.681205124 | 0.00010796 |
| MspFrag3927 | 1 | 25917246 | 25917338 | 1.269558201 | 3.559279727 | 0.00011165 |
| MspFrag30986 | 3 | 193609230 | 193609392 | 1.245575966 | 3.474935668 | 0.00011264 |
| MspFrag115742 | 16 | 66962925 | 66962981 | 1.254515702 | 3.506139945 | 0.00012217 |
| MspFrag17645 | 2 | 73372031 | 73372177 | −1.306674604 | 3.693869686 | 0.00012413 |
| MspFrag16080 | 2 | 38741040 | 38741184 | −1.279815659 | 3.595976778 | 0.00013384 |
| MspFrag150780 | 22 | 29356521 | 29357007 | 1.254524729 | 3.506171597 | 0.00013458 |
| MspFrag26377 | 3 | 47397573 | 47397640 | 1.338400615 | 3.812940265 | 0.00013826 |
| MspFrag35993 | 4 | 124676307 | 124676421 | −1.316549138 | 3.730525612 | 0.00013993 |
| MspFrag5194 | 1 | 38066662 | 38066799 | −1.258013295 | 3.518424468 | 0.00014150 |
| MspFrag109349 | 15 | 89338732 | 89338920 | −1.274957867 | 3.578550631 | 0.00014220 |
| MspFrag147611 | 21 | 33320852 | 33321107 | 1.543350193 | 4.680243755 | 0.00015554 |
| MspFrag149235 | 22 | 15940422 | 15940502 | −1.430901137 | 4.18246647 | 0.00016381 |
| MspFrag8137 | 1 | 107395242 | 107395391 | −1.216889112 | 3.376666946 | 0.00017533 |
| MspFrag16688 | 2 | 53998571 | 53998619 | 1.281990195 | 3.603804867 | 0.00019236 |
| MspFrag53047 | 7 | 2045802 | 2045886 | −1.200682908 | 3.322385032 | 0.00019289 |
| MspFrag77192 | 10 | 69660903 | 69660951 | 1.397052085 | 4.043263184 | 0.00022122 |
| MspFrag151812 | 22 | 40189865 | 40189930 | 1.524071062 | 4.590876949 | 0.00022359 |
| MspFrag53500 | 7 | 5326453 | 5326533 | −1.205457286 | 3.338285281 | 0.00022412 |
| MspFrag109222 | 15 | 88446282 | 88446335 | 1.741117904 | 5.703716068 | 0.00022444 |
| MspFrag26870 | 3 | 50349984 | 50350040 | 1.295072636 | 3.651261176 | 0.00022456 |
| MspFrag21005 | 2 | 161089693 | 161089859 | −1.261776369 | 3.531689502 | 0.00022934 |
| MspFrag25408 | 3 | 24511219 | 24511396 | −1.333152131 | 3.792980537 | 0.00022935 |
| MspFrag150835 | 22 | 29844398 | 29845889 | 1.275213434 | 3.579465309 | 0.00022999 |
| MspFrag135435 | 19 | 13074482 | 13074572 | −1.216310101 | 3.374712384 | 0.00024377 |
| MspFrag123321 | 17 | 45008675 | 45008740 | −1.19062523 | 3.289137032 | 0.00024446 |
| MspFrag115170 | 16 | 57220436 | 57220551 | −1.207309221 | 3.344473295 | 0.00024697 |
| MspFrag59037 | 7 | 135119364 | 135119483 | −1.381764471 | 3.981921418 | 0.00024713 |
| MspFrag131452 | 19 | 876428 | 876538 | −1.183697217 | 3.2664286 | 0.00025321 |
| MspFrag85257 | 11 | 61104518 | 61104615 | 1.186889303 | 3.27687198 | 0.00025494 |
| MspFrag68522 | 9 | 36181413 | 36181517 | −1.175843915 | 3.240876814 | 0.00025777 |
| MspFrag14700 | 2 | 10213943 | 10214077 | −1.173429889 | 3.23306269 | 0.00026245 |
| MspFrag561 | 1 | 1325104 | 1325199 | −1.277188384 | 3.586541558 | 0.00027762 |
| MspFrag66441 | 8 | 144983389 | 144983533 | −1.315657665 | 3.727201428 | 0.00028420 |
| MspFrag53832 | 7 | 8074272 | 8074335 | −1.170075798 | 3.22223687 | 0.00029780 |
| MspFrag26652 | 3 | 49424481 | 49424611 | −1.173594694 | 3.233595557 | 0.00030916 |
| MspFrag153253 | 22 | 49329384 | 49329446 | −1.158630509 | 3.18556768 | 0.0003305 |
| MspFrag28000 | 3 | 95264573 | 95264687 | −1.475299941 | 4.372347021 | 0.00034335 |
| MspFrag17684 | 2 | 73432009 | 73432110 | −1.20591908 | 3.339827235 | 0.00034366 |
| MspFrag109745 | 15 | 98902576 | 98902651 | 1.20379499 | 3.332740673 | 0.00034497 |
| MspFrag122119 | 17 | 37828834 | 37828845 | 1.219347679 | 3.384978921 | 0.00034510 |
| MspFrag136811 | 19 | 19175104 | 19175214 | −1.159190875 | 3.187353264 | 0.00035311 |
| MspFrag62958 | 8 | 38973512 | 38973643 | −1.170641816 | 3.224061227 | 0.00035759 |
| MspFrag137298 | 19 | 37859582 | 37859892 | 1.226901581 | 3.410645537 | 0.00036676 |
| MspFrag91943 | 12 | 48248221 | 48248353 | −1.160064148 | 3.19013791 | 0.00037119 |
| MspFrag71001 | 9 | 112328891 | 112329042 | −1.25789713 | 3.518015774 | 0.00037729 |
| MspFrag147443 | 21 | 29318780 | 29318834 | 1.153927984 | 3.170622638 | 0.00038384 |
| MspFrag54893 | 7 | 32770006 | 32770091 | −1.187404805 | 3.278561649 | 0.00038497 |
| MspFrag25566 | 3 | 31549688 | 31549742 | 1.149862318 | 3.157758114 | 0.00039262 |
| MspFrag36943 | 4 | 170566260 | 170566316 | 1.29804138 | 3.662116942 | 0.00039276 |
| MspFrag51099 | 6 | 146177698 | 146177821 | −1.285514816 | 3.616529325 | 0.00040494 |
| MspFrag56570 | 7 | 74684498 | 74684616 | −1.386801811 | 4.002030316 | 0.00040673 |
| MspFrag134464 | 19 | 8021176 | 8021419 | 1.466122574 | 4.332403955 | 0.00040884 |
| MspFrag16502 | 2 | 46681851 | 46681939 | −1.218021896 | 3.380494147 | 0.00041282 |
| MspFrag77773 | 10 | 76835693 | 76835926 | 1.16246764 | 3.197814604 | 0.00041463 |
| MspFrag17516 | 2 | 72285546 | 72286072 | 1.214542079 | 3.36875109 | 0.00041905 |
| MspFrag38381 | 5 | 1249403 | 1253323 | 1.159150836 | 3.187225648 | 0.00042275 |
| MspFrag100461 | 14 | 23771465 | 23771584 | −1.221721203 | 3.393022791 | 0.00042509 |
| MspFrag142563 | 20 | 2030360 | 2030434 | −1.150566592 | 3.159982823 | 0.00044078 |
| MspFrag27344 | 3 | 57516816 | 57517032 | −1.182899974 | 3.263825503 | 0.00094902 |
| MspFrag3459 | 1 | 21740313 | 21740824 | 1.073816306 | 2.926526738 | 0.00235154 |
| MspFrag108957 | 15 | 83724945 | 83725020 | −1.036099724 | 2.818203779 | 0.00211551 |
| MspFrag8952 | 1 | 120550938 | 120551015 | −1.082824996 | 2.953010019 | 0.00487630 |
| MspFrag140544 | 19 | 54859521 | 54859584 | 0.9285114 | 2.530739115 | 0.00475232 |
| MspFrag95374 | 12 | 121969175 | 121969327 | 2.038032885 | 7.675495752 | 0.00096037 |
| MspFrag11084 | 1 | 177203519 | 177203591 | −1.117111474 | 3.056014065 | 0.00102227 |
| MspFrag59757 | 7 | 150183744 | 150183866 | 1.044313739 | 2.841447879 | 0.00131907 |
| MspFrag106873 | 15 | 56828418 | 56828517 | −1.055868154 | 2.874469553 | 0.00609718 |
| MspFrag147401 | 21 | 27259728 | 27259787 | 1.452181347 | 4.272423998 | 0.00109664 |
| MspFrag49820 | 6 | 107064926 | 107065091 | −1.079593532 | 2.943482876 | 0.00263732 |
| MspFrag42074 | 5 | 129269283 | 129269763 | 0.921987246 | 2.514281925 | 0.00696153 |
| MspFrag51717 | 6 | 161383219 | 161383312 | −1.084195993 | 2.957061365 | 0.00117523 |
| MspFrag3222 | 1 | 19384170 | 19384247 | 1.066272699 | 2.90453323 | 0.00151871 |
| MspFrag19458 | 2 | 112357644 | 112357785 | −1.225056064 | 3.404356939 | 0.00227083 |
| MspFrag73969 | 9 | 137359001 | 137359081 | −1.036624047 | 2.819681815 | 0.00520580 |
| MspFrag12743 | 1 | 224576513 | 224576561 | 1.45002933 | 4.263239553 | 0.00300809 |
| MspFrag39715 | 5 | 39110153 | 39110260 | −1.101157328 | 3.007644842 | 0.00083967 |
| MspFrag11834 | 1 | 202766786 | 202766874 | 1.415693768 | 4.119343345 | 0.00388705 |
| MspFrag126314 | 17 | 76811338 | 76811398 | 1.131904655 | 3.101558277 | 0.00070822 |
| MspFrag40542 | 5 | 72452265 | 72452290 | 1.148666336 | 3.153983749 | 0.00688232 |
| MspFrag24106 | 2 | 240059643 | 240059794 | −1.089842276 | 2.973804996 | 0.00181991 |
| MspFrag120320 | 17 | 20000217 | 20000365 | −0.889177704 | 2.433128076 | 0.00708168 |
| MspFrag70056 | 9 | 93796287 | 93796379 | 0.984117774 | 2.675450492 | 0.00318950 |
| MspFrag86363 | 11 | 65443997 | 65444104 | −1.016008435 | 2.762147439 | 0.00182606 |
| MspFrag139381 | 19 | 50373573 | 50373685 | −1.134182219 | 3.108630323 | 0.00480460 |
| MspFrag62960 | 8 | 38973782 | 38973852 | 1.155053774 | 3.174194101 | 0.00254312 |
| MspFrag100832 | 14 | 35365341 | 35365430 | 1.214635002 | 3.36906414 | 0.00091244 |
| MspFrag133083 | 19 | 3175833 | 3176005 | −1.040327852 | 2.83014473 | 0.00400110 |
| MspFrag11657 | 1 | 200006899 | 200006982 | −0.96511676 | 2.625094145 | 0.00505874 |
| MspFrag146227 | 20 | 60415939 | 60416050 | −0.925883637 | 2.524097662 | 0.00475275 |
| MspFrag93394 | 12 | 74070411 | 74071066 | −1.278548939 | 3.591424567 | 0.00081373 |
| MspFrag58081 | 7 | 106977741 | 106977868 | −1.004793718 | 2.731343787 | 0.00211868 |
| MspFrag148361 | 21 | 43368939 | 43369016 | −1.068903029 | 2.912183167 | 0.00103324 |
| MspFrag10593 | 1 | 160023351 | 160023503 | −1.08334757 | 2.95455359 | 0.00250483 |
| MspFrag121058 | 17 | 27838735 | 27838784 | 0.94830262 | 2.581324451 | 0.00499502 |
| MspFrag145430 | 20 | 48242328 | 48242412 | −1.088565288 | 2.970009905 | 0.00233079 |
| MspFrag15995 | 2 | 37370187 | 37370286 | −0.963536624 | 2.620949413 | 0.00510293 |
| MspFrag33696 | 4 | 36068269 | 36068333 | 1.033928126 | 2.812090413 | 0.00392967 |
| MspFrag152161 | 22 | 42676139 | 42676235 | −0.987033877 | 2.683263768 | 0.00275928 |
| MspFrag101472 | 14 | 54046402 | 54046513 | −1.056338591 | 2.87582213 | 0.00269909 |
| MspFrag142281 | 19 | 63758361 | 63758463 | −0.932586597 | 2.541073419 | 0.00526145 |
| MspFrag108413 | 15 | 76720543 | 76720613 | 1.759901852 | 5.811866941 | 0.00097824 |
| MspFrag53083 | 7 | 2215660 | 2216033 | −1.04435046 | 2.841552223 | 0.00227004 |
| MspFrag53084 | 7 | 2216034 | 2216150 | −1.105395638 | 3.020419226 | 0.00401867 |
| MspFrag47176 | 6 | 31741672 | 31741757 | −0.905880924 | 2.474110467 | 0.00684941 |
| MspFrag117641 | 16 | 88280539 | 88280695 | −0.970438329 | 2.639101001 | 0.00301667 |
| MspFrag94478 | 12 | 109934892 | 109935041 | −1.092263585 | 2.981014219 | 0.00075440 |
| MspFrag43723 | 5 | 156626146 | 156626662 | 1.058158751 | 2.88106135 | 0.00227660 |
| MspFrag31375 | 3 | 198513651 | 198513786 | −1.092995165 | 2.983195869 | 0.00224187 |
| MspFrag67346 | 9 | 962115 | 962267 | −1.15673378 | 3.179531249 | 0.00121185 |
| MspFrag134765 | 19 | 10166684 | 10166754 | −0.915473394 | 2.49795749 | 0.00624067 |
| MspFrag18534 | 2 | 96232849 | 96232973 | −0.913004905 | 2.491798914 | 0.00544038 |
| MspFrag45247 | 6 | 237511 | 237619 | −1.082259546 | 2.951340712 | 0.00087232 |
| MspFrag11853 | 1 | 203197286 | 203197373 | −1.136126949 | 3.114681652 | 0.00058214 |
| MspFrag24662 | 3 | 5204530 | 5204673 | −1.038047295 | 2.823697779 | 0.00241093 |
| MspFrag136920 | 19 | 19597987 | 19599415 | 1.099048943 | 3.001310248 | 0.00432140 |
| MspFrag41049 | 5 | 83715416 | 83715472 | 1.259033277 | 3.522015029 | 0.00089930 |
| MspFrag61819 | 8 | 16929196 | 16929279 | 0.923344367 | 2.517696428 | 0.00521799 |
| MspFrag99173 | 13 | 105986344 | 105986494 | −0.900042228 | 2.459706978 | 0.00604371 |
| MspFrag138820 | 19 | 45998408 | 46000340 | 1.19165021 | 3.292510061 | 0.00080642 |
| MspFrag136016 | 19 | 16443907 | 16444709 | 1.050188182 | 2.858188928 | 0.00158992 |
| MspFrag87098 | 11 | 69228110 | 69228133 | 0.888369877 | 2.431163324 | 0.00706389 |
| MspFrag69085 | 9 | 67936549 | 67936620 | −1.007319409 | 2.738251037 | 0.00201106 |
| MspFrag116828 | 16 | 85102579 | 85102687 | 1.410670151 | 4.098701234 | 0.00065978 |
| MspFrag100578 | 14 | 28307145 | 28307331 | 1.005238062 | 2.732557714 | 0.00411296 |
| MspFrag125321 | 17 | 71647858 | 71647909 | 1.161205272 | 3.193780332 | 0.00242263 |
| MspFrag29581 | 3 | 140147240 | 140147263 | 0.943624724 | 2.569277483 | 0.00541360 |
| MspFrag122501 | 17 | 39990561 | 39990641 | 1.067107566 | 2.90695914 | 0.00219902 |
| MspFrag42857 | 5 | 139705730 | 139705779 | 0.915189305 | 2.497247949 | 0.00704962 |
| MspFrag10141 | 1 | 153534086 | 153534149 | 1.217684191 | 3.379352728 | 0.00397521 |
| MspFrag139675 | 19 | 51495479 | 51496643 | 0.995673914 | 2.706547708 | 0.00457281 |
| MspFrag46589 | 6 | 26152253 | 26152316 | −1.141104644 | 3.13022424 | 0.00156369 |
| MspFrag9354 | 1 | 146625164 | 146625283 | −1.049366489 | 2.855841338 | 0.00348711 |
| MspFrag47574 | 6 | 34311500 | 34311607 | −1.144443142 | 3.140691949 | 0.00044554 |
| MspFrag17791 | 2 | 74593709 | 74593793 | −1.090571991 | 2.975975819 | 0.00140982 |
| MspFrag92442 | 12 | 52654220 | 52654341 | −0.906379965 | 2.475345456 | 0.00588533 |
| MspFrag82007 | 11 | 524896 | 524996 | −1.094195683 | 2.986779398 | 0.00308735 |
| MspFrag31023 | 3 | 194442010 | 194442062 | 1.011819338 | 2.750600739 | 0.00241045 |
| MspFrag85516 | 11 | 63137739 | 63137841 | 1.788305986 | 5.97931484 | 0.00076306 |
| MspFrag38798 | 5 | 2806468 | 2806837 | 1.632282135 | 5.115535752 | 0.00279745 |
| MspFrag38676 | 5 | 1939525 | 1939781 | 1.017889203 | 2.767347286 | 0.00217145 |
| MspFrag6819 | 1 | 58962596 | 58962729 | −0.955560641 | 2.600127913 | 0.00474858 |
| MspFrag136496 | 19 | 18251538 | 18251602 | −0.986771246 | 2.682559152 | 0.00247024 |
| MspFrag28787 | 3 | 127557979 | 127558235 | 1.011409333 | 2.74947321 | 0.00239671 |
| MspFrag70811 | 9 | 107330272 | 107330386 | −1.050930468 | 2.860311308 | 0.00150964 |
| MspFrag122014 | 17 | 37274994 | 37275055 | 1.006077872 | 2.734853508 | 0.00302918 |
| MspFrag1897 | 1 | 6597633 | 6597814 | −1.113547496 | 3.045141884 | 0.00087165 |
| MspFrag141540 | 19 | 60687090 | 60687272 | 1.03952324 | 2.827868478 | 0.00197839 |
| MspFrag141543 | 19 | 60687608 | 60687968 | 0.873091939 | 2.394302458 | 0.00813383 |
| MspFrag71516 | 9 | 123850195 | 123850317 | −0.970854584 | 2.640199768 | 0.00426285 |
| MspFrag73368 | 9 | 136322430 | 136322760 | 0.889874074 | 2.434823025 | 0.00736889 |
| MspFrag7599 | 1 | 87506542 | 87506717 | −0.999198592 | 2.716104249 | 0.00217074 |
| MspFrag58527 | 7 | 127266400 | 127266460 | −1.005530442 | 2.733356775 | 0.00515331 |
| MspFrag116376 | 16 | 78192209 | 78192354 | −1.085585143 | 2.96117202 | 0.00085302 |
| MspFrag102064 | 14 | 64639425 | 64639524 | −1.084916348 | 2.959192266 | 0.00088421 |
| MspFrag30605 | 3 | 184626369 | 184628268 | 0.949282901 | 2.583856114 | 0.00381059 |
| MspFrag108582 | 15 | 79080083 | 79080151 | 1.220893072 | 3.390214086 | 0.00421640 |
| MspFrag108575 | 15 | 79068949 | 79069041 | −0.927000808 | 2.526919085 | 0.00560641 |
| MspFrag127216 | 17 | 78625882 | 78625989 | 1.009883353 | 2.745280769 | 0.00234648 |
| MspFrag118382 | 17 | 2251392 | 2251491 | −0.935342013 | 2.548084787 | 0.00656938 |
| MspFrag95585 | 12 | 123528244 | 123528308 | 0.930194592 | 2.535002421 | 0.00634586 |
| MspFrag143622 | 20 | 21442251 | 21442378 | −1.115604049 | 3.051410823 | 0.00385263 |
| MspFrag11208 | 1 | 180118485 | 180118629 | 1.043517668 | 2.839186786 | 0.00360524 |
| MspFrag144608 | 20 | 35584530 | 35584728 | 1.023838605 | 2.783860421 | 0.00436564 |
| MspFrag9029 | 1 | 142697968 | 142698037 | −1.213018303 | 3.363621776 | 0.00147013 |
| MspFrag147637 | 21 | 33364989 | 33365015 | −1.256659406 | 3.513664134 | 0.00285152 |
| MspFrag147602 | 21 | 33317943 | 33319189 | 1.220478819 | 3.388809971 | 0.00090124 |
| MspFrag106694 | 15 | 50868656 | 50868704 | 1.377045942 | 3.963176865 | 0.00511711 |
| MspFrag3120 | 1 | 18704668 | 18704788 | −0.890216962 | 2.435658039 | 0.00726803 |
| MspFrag100936 | 14 | 36201449 | 36201600 | −1.181974297 | 3.260805651 | 0.00049733 |
| MspFrag40155 | 5 | 57791657 | 57791770 | −1.051468269 | 2.86185 | 0.00126368 |
| MspFrag86714 | 11 | 66877439 | 66877499 | 1.023450818 | 2.782781084 | 0.00275147 |
| MspFrag94152 | 12 | 105253943 | 105254046 | −0.924584717 | 2.520821189 | 0.00642069 |
| MspFrag9042 | 1 | 142959564 | 142959635 | −0.910693842 | 2.486046859 | 0.00745161 |
| MspFrag109916 | 16 | 43459 | 43567 | −0.99266134 | 2.698406301 | 0.00286520 |
| MspFrag10700 | 1 | 163921454 | 163921626 | −0.976312694 | 2.654649668 | 0.00296120 |
| MspFrag19019 | 2 | 104931256 | 104931658 | 1.109704022 | 3.033460423 | 0.00622465 |
| MspFrag6759 | 1 | 56756288 | 56756461 | −0.950350208 | 2.586615353 | 0.00594939 |
| MspFrag16292 | 2 | 44307049 | 44307127 | −1.21659635 | 3.37567853 | 0.00090197 |
| MspFrag8568 | 1 | 112969217 | 112969314 | −0.885107485 | 2.42324484 | 0.00754428 |
| MspFrag145985 | 20 | 57948390 | 57948510 | −1.05089298 | 2.860204084 | 0.00175439 |
| MspFrag158744 | 24 | 272566 | 272729 | 1.091476219 | 2.978667994 | 0.00110824 |
| MspFrag155565 | 23 | 48684411 | 48685972 | 1.138354009 | 3.121625965 | 0.00044715 |
| MspFrag155566 | 23 | 48685973 | 48686100 | 1.137834404 | 3.120004376 | 0.00073095 |
| MspFrag155569 | 23 | 48686268 | 48686347 | 0.977882537 | 2.658820322 | 0.00273933 |
| MspFrag69137 | 9 | 68858188 | 68858363 | 1.041189514 | 2.83258441 | 0.00191841 |
| MspFrag123482 | 17 | 45829715 | 45829856 | −0.991475809 | 2.695209152 | 0.00381636 |
| MspFrag78238 | 10 | 89612230 | 89612351 | −1.100252672 | 3.004925188 | 0.00070312 |
| MspFrag24971 | 3 | 12680778 | 12680878 | −1.052698233 | 2.865372138 | 0.00174892 |
| MspFrag25433 | 3 | 25446589 | 25451329 | 1.023473607 | 2.782844501 | 0.00169034 |
| MspFrag57886 | 7 | 101751800 | 101751887 | −1.142530942 | 3.134692058 | 0.00284821 |
| MspFrag57901 | 7 | 101850994 | 101851081 | −1.047656704 | 2.850962635 | 0.00354585 |
| MspFrag105773 | 15 | 36644750 | 36646339 | 1.181470651 | 3.259163773 | 0.00541497 |
| MspFrag11846 | 1 | 203118853 | 203118980 | −0.922449775 | 2.515445124 | 0.00583294 |
| MspFrag107389 | 15 | 64780562 | 64780683 | −1.047824722 | 2.851441689 | 0.00155451 |
| MspFrag17134 | 2 | 65569229 | 65569419 | 0.915332355 | 2.497605204 | 0.00671520 |
| MspFrag98583 | 13 | 79813402 | 79813505 | −0.954558828 | 2.597524375 | 0.00398573 |
| MspFrag106230 | 15 | 41572634 | 41572828 | −1.007921281 | 2.739899609 | 0.00666122 |
| MspFrag115404 | 16 | 65751209 | 65751304 | 0.987022832 | 2.68323413 | 0.00617653 |
| MspFrag26471 | 3 | 48460777 | 48462965 | 1.117559386 | 3.057383199 | 0.00078698 |
| MspFrag91425 | 12 | 40917728 | 40917808 | −1.011103903 | 2.748633565 | 0.00675021 |

| | Poor | Good | | |
|---|---|---|---|---|
| | Progn. | Progn. | | |
| MspFragID | State | State | GeneSymbol | GeneDescription |
| MspFrag12449 | −1 | 0 | AY221751 | Myocardial ischemic preconditioning |
| | | | | upregulated protein 2 |
| MspFrag157734 | 1 | 0 | FHL1 | four and a half LIM domains 1 |
| MspFrag151940 | −1 | 0 | LOC91689 | hypothetical protein LOC91689 |
| MspFrag105924 | 1 | 0 | D4ST1 | dermatan 4 sulfotransferase 1 |
| MspFrag22802 | 1 | 0 | FEV | FEV (ETS oncogene family) |
| MspFrag90914 | −1 | 0 | BC033804 | ABCC9 protein. |
| MspFrag144132 | 1 | 0 | LOC149950 | hypothetical protein LOC149950 |
| MspFrag148589 | 1 | 0 | C21orf2 | chromosome 21 open reading frame 2 |
| MspFrag75113 | −1 | 0 | CAMK1D | calcium/calmodulin-dependent protein kinase |
| | | | | ID |
| MspFrag36468 | 1 | 0 | AK131430 | Hypothetical protein FLJ16555. |
| MspFrag145054 | −1 | 0 | UBE2C | ubiquitin-conjugating enzyme E2C isoform 4 |
| MspFrag155417 | 1 | 0 | UXT | ubiquitously-expressed transcript isoform 2 |
| MspFrag38306 | 1 | 0 | NKD2 | naked cuticle homolog 2 |
| MspFrag8611 | −1 | 0 | MAGI3 | membrane-associated guanylate kinase- |
| | | | | related 3 |
| MspFrag10298 | −1 | 0 | BC013107 | WD repeat domain 42A (Fragment). |
| MspFrag144777 | −1 | 0 | TOP1 | DNA topoisomerase I |
| MspFrag131356 | 1 | 0 | PRTN3 | proteinase 3 (serine proteinase, neutrophil, |
| MspFrag3468 | −1 | 0 | CR619608 | Ubiquitin specific protease 48./ubiquitin |
| | | | | specific protease 48 |
| MspFrag56306 | 1 | 0 | NSUN5 | NOL1/NOP2/Sun domain family, member 5 |
| | | | | isoform 1 |
| MspFrag141448 | 1 | 0 | IL11 | interleukin 11 precursor |
| MspFrag44952 | 1 | 0 | AK125253 | Hypothetical protein FLJ43263 |
| MspFrag109776 | 1 | 0 | LOC440313 | hypothetical protein LOC440313 |
| MspFrag74125 | 1 | 0 | AK055004 | Hypothetical protein FLJ30442 |
| MspFrag1715 | 1 | 0 | RPL22 | ribosomal protein L22 proprotein |
| MspFrag26474 | −1 | 0 | TREX1 | three prime repair exonuclease 1 isoform d |
| MspFrag336 | 1 | 0 | AK128271 | Hypothetical protein FLJ46577 |
| MspFrag26271 | 1 | 0 | TDGF1 | teratocarcinoma-derived growth factor 1 |
| MspFrag131504 | 1 | 0 | GRIN3B | glutamate receptor, ionotropic |
| MspFrag89957 | 1 | 0 | WNT5B | wingless-type MMTV integration site family |
| MspFrag69663 | −1 | 0 | FLJ45537 | hypothetical protein LOC401535 |
| MspFrag148520 | 1 | 0 | C21orf33 | es1 protein isoform Ia precursor |
| MspFrag32887 | 1 | 0 | AK131366 | Hypothetical protein FLJ16408 |
| MspFrag26260 | −1 | 0 | FYCO1 | FYVE and coiled-coil domain containing 1 |
| MspFrag20166 | −1 | 0 | MGC4268 | hypothetical protein LOC83607 |
| MspFrag66968 | 1 | 0 | FOXH1 | forkhead box H1/KIFC2 protein. |
| MspFrag117001 | 1 | 0 | AK092895 | Hypothetical protein FLJ35576. |
| MspFrag67675 | −1 | 0 | JMJD2C | jumonji domain containing 2C |
| MspFrag89277 | −1 | 0 | FLJ23342 | hypothetical protein LOC79684 |
| MspFrag41501 | 1 | 0 | PJA2 | praja 2, RING-H2 motif containing |
| MspFrag10351 | −1 | 0 | NDUFS2 | NADH dehydrogenase (ubiquinone) Fe—S |
| | | | | protein 2, 49 kDa |
| MspFrag89167 | 1 | 0 | BC016179 | Uncharacterized bone marrow protein BM034. |
| MspFrag3927 | 1 | 0 | STMN1 | stathmin 1 |
| MspFrag30986 | 0 | −1 | FGF12 | fibroblast growth factor 12 isoform 1 |
| MspFrag115742 | 1 | 0 | AK128261 | Hypothetical protein FLJ46397 |
| MspFrag17645 | −1 | 0 | CCT7/C2orf7 | chaperonin containing TCP1, subunit 7 |
| | | | | isoform a |
| MspFrag16080 | −1 | 0 | AY236962 | Stromal RNA regulating factor |
| MspFrag150780 | 0 | −1 | SLC35E4 | solute carrier family 35, member E4 |
| MspFrag26377 | 1 | 0 | BC089042 | Protein tyrosine phosphatase, non-receptor |
| | | | | type 23 |
| MspFrag35993 | −1 | 0 | SPRY1 | sprouty homolog 1, antagonist of FGF |
| | | | | signaling |
| MspFrag5194 | −1 | 0 | INPP5B | inositol poly-phosphate-5-phosphatase, 75 kDa |
| MspFrag109349 | −1 | 0 | PRC1 | protein regulator of cytokinesis 1 isoform 2 |
| MspFrag147611 | 0 | −1 | OLIG2 | oligodendrocyte lineage transcription factor 2 |
| MspFrag149235 | −1 | 0 | IL17R | interleukin 17 receptor precursor |
| MspFrag8137 | −1 | 0 | AB023193 | Splice isoform 2 of Q9Y2I2/netrin G1 |
| MspFrag16688 | 1 | 0 | GPR75 | G protein-coupled receptor 75 |
| MspFrag53047 | −1 | 0 | MAD1L1 | MAD1-like 1 protein/MAD1-like 1 protein |
| MspFrag77192 | 1 | 0 | ATOH7 | atonal homolog 7 |
| MspFrag151812 | 1 | 0 | PHF5A | PHD-finger 5A/aconitase 2, mitochondrial |
| MspFrag53500 | −1 | 0 | FBXL18 | F-box and leucine-rich repeat protein 18 |
| MspFrag109222 | 1 | 0 | IDH2 | isocitrate dehydrogenase 2 (NADP+) |
| MspFrag26870 | 1 | 0 | RASSF1 | Ras association domain family 1 isoform |
| | | | | B/isoform C |
| MspFrag21005 | −1 | 0 | RBMS1 | RNA binding motif, single stranded interacting |
| | | | | protein 1 |
| MspFrag25408 | −1 | 0 | THRB | thyroid hormone receptor, beta |
| MspFrag150835 | 1 | 0 | PIB5PA | phosphatidylinositol (4,5) bisphosphate |
| MspFrag135435 | −1 | 0 | LYL1 | lymphoblastic leukemia derived sequence 1 |
| MspFrag123321 | −1 | 0 | NXPH3 | neurexophilin 3 |
| MspFrag115170 | −1 | 0 | CNOT1 | CCR4-NOT transcription complex, subunit 1 |
| MspFrag59037 | −1 | 0 | MTPN | myotrophin |
| MspFrag131452 | −1 | 0 | ARID3A | AT rich interactive domain 3A (BRIGHT-like) |
| MspFrag85257 | 1 | 0 | SYT7 | synaptotagmin VII |
| MspFrag68522 | −1 | 0 | CLTA | clathrin, light polypeptide A isoform b |
| MspFrag14700 | −1 | 0 | RRM2 | ribonucleotide reductase M2 polypeptide |
| MspFrag561 | −1 | 0 | DVL1 | dishevelled 1 isoform b |
| MspFrag66441 | −1 | 0 | SIAHBP1 | fuse-binding protein-interacting repressor |
| MspFrag53832 | −1 | 0 | ICA1 | islet cell autoantigen 1 isoform 1 |
| MspFrag26652 | −1 | 0 | RHOA | ras homolog gene family, member A |
| MspFrag153253 | −1 | 0 | MAPK8IP2 | mitogen-activated protein kinase 8 interacting |
| MspFrag28000 | −1 | 0 | DHFRL1 | NOL1/NOP2/Sun domain family, member 3 |
| MspFrag17684 | −1 | 0 | EGR4 | early growth response 4 |
| MspFrag109745 | 1 | 0 | LASS3 | hypothetical protein LOC204219 |
| MspFrag122119 | 1 | 0 | PTRF | polymerase I and transcript release factor |
| MspFrag136811 | −1 | 0 | TRA16 | TR4 orphan receptor associated protein |
| | | | | TRA16 |
| MspFrag62958 | −1 | 0 | ADAM9 | a disintegrin and metalloproteinase domain 9 |
| MspFrag137298 | 1 | 0 | BC045605 | Hypothetical protein DKFZp434L0718 |
| MspFrag91943 | −1 | 0 | MCRS1 | microspherule protein 1 isoform 1 |
| MspFrag71001 | −1 | 0 | KIAA1958 | hypothetical protein LOC158405 |
| MspFrag147443 | 1 | 0 | USP16 | ubiquitin specific protease 16 isoform a |
| MspFrag54893 | −1 | 0 | FKBP9 | FK506 binding protein 9 |
| MspFrag25566 | 1 | 0 | SIMP | source of immunodominant MHC-associated |
| MspFrag36943 | 1 | 0 | SH3MD2 | SH3 multiple domains 2 |
| MspFrag51099 | −1 | 0 | FBXO30 | F-box only protein 30 |
| MspFrag56570 | −1 | 0 | WBSCR20B | Williams-Beuren Syndrome critical region |
| | | | | protein |
| MspFrag134464 | 1 | 0 | CCL25 | small inducible cytokine A25 isoform 1 |
| MspFrag16502 | −1 | 0 | RHOQ | ras-like protein TC10 |
| MspFrag77773 | 1 | 0 | BC007494 | ZNF503 protein |
| MspFrag17516 | 0 | −1 | BC069443 | Hypothetical protein DKFZp686G0638. |
| MspFrag38381 | 1 | 0 | AK096054 | Hypothetical protein FLJ34635 |
| MspFrag100461 | −1 | 0 | GMPR2 | guanosine monophosphate reductase 2 |
| | | | | isoform 2 |
| MspFrag142563 | −1 | 0 | STK35 | serine/threonine kinase 35 |
| MspFrag27344 | −1 | 0 | 2′-PDE | 2′-phosphodiesterase |
| MspFrag3459 | 0 | −1 | AB007943 | RAP1, GTPase activating protein 1. |
| MspFrag108957 | −1 | 0 | AB055890 | Non-ocogenic Rho GTPase-specific GTP |
| | | | | exchange factor |
| MspFrag8952 | −1 | 0 | AB096683 | Gastric cancer up-regulated-2 |
| MspFrag140544 | 1 | 0 | AB102884 | Interferon regulatory factor 3 nirs variant 1 |
| MspFrag95374 | 1 | 0 | ABCB9 | ATP-binding cassette, sub-family B |
| | | | | (MDR/TAP), member 9 |
| MspFrag11084 | −1 | 0 | ACBD6 | acyl-Coenzyme A binding domain containing 6 |
| MspFrag59757 | 1 | 0 | ACCN3 | amiloride-sensitive cation channel 3 isoform c |
| MspFrag106873 | −1 | 0 | ADAM10 | a disintegrin and metalloprotease domain 10 |
| MspFrag147401 | 1 | 0 | ADAMTS5 | a disintegrin and metalloprotease with |
| MspFrag49820 | −1 | 0 | AIM1 | absent in melanoma 1 |
| MspFrag42074 | 0 | −1 | AJ578034 | Chondroitin sulfate synthase 3 (EC 2.4.1.175) |
| MspFrag51717 | −1 | 0 | AK094629 | Hypothetical protein FLJ37310 |
| MspFrag3222 | 1 | 0 | AKR7A2 | aldo-keto reductase family 7, member A2 |
| MspFrag19458 | −1 | 0 | ANAPC1 | anaphase promoting complex subunit 1 |
| MspFrag73969 | −1 | 0 | ANAPC2 | anaphase-promoting complex subunit 2 |
| MspFrag12743 | 1 | 0 | ARF1 | ADP-ribosylation factor 1 |
| MspFrag39715 | −1 | 0 | AVO3 | rapamycin-insensitive companion of mTOR |
| MspFrag11834 | 1 | 0 | AVPR1B | arginine vasopressin receptor 1B |
| MspFrag126314 | 1 | 0 | AZI1 | 5-azacytidine induced 1 isoform a |
| MspFrag40542 | 0 | −1 | BC035310 | Hypothetical protein LOC134285 |
| MspFrag24106 | −1 | 0 | BC039904 | HDAC4 protein. |
| MspFrag120320 | −1 | 0 | BC050058 | HCMOGT-1 protein. |
| MspFrag70056 | 1 | 0 | BC064363 | BarH-like homeobox 1. |
| MspFrag86363 | −1 | 0 | BlES03 | basophilic leukemia expressed protein |
| | | | | BLES03 |
| MspFrag139381 | −1 | 0 | BLOC1S3 | biogenesis of lysosome-related organelles |
| MspFrag62960 | 1 | 0 | BLP1 | BBP-like protein 1 isoform a |
| MspFrag100832 | 1 | 0 | BRMS1L | breast cancer metastasis-suppressor 1-like |
| MspFrag133083 | −1 | 0 | BRUNOL5 | bruno-like 5, RNA binding protein |
| MspFrag11657 | −1 | 0 | BTG2 | B-cell translocation gene 2 |
| MspFrag146227 | −1 | 0 | CABLES2 | Cdk5 and Abl enzyme substrate 2 |
| MspFrag93394 | −1 | 0 | CAPS2 | calcyphosphine 2 |
| MspFrag58081 | −1 | 0 | CBLL1 | Cas-Br-M (murine) ecotropic retroviral |
| MspFrag148361 | −1 | 0 | CBS | cystathionine-beta-synthase |
| MspFrag10593 | −1 | 0 | CDCA1 | cell division cycle associated 1 |
| MspFrag121058 | 1 | 0 | CDK5R1 | cyclin-dependent kinase 5, regulatory subunit 1 |
| MspFrag145430 | −1 | 0 | CEBPB | CCAAT/enhancer binding protein beta |
| MspFrag15995 | −1 | 0 | CEBPZ | CCAAT/enhancer binding protein zeta |
| MspFrag33696 | 1 | 0 | CENTD1 | centaurin delta 1 isoform a |
| MspFrag152161 | −1 | 0 | CGI-51 | CGI-51 protein/CGI-51 protein |
| MspFrag101472 | −1 | 0 | CGRRF1 | cell growth regulator with ring finger domain 1 |
| MspFrag142281 | −1 | 0 | CHMP2A | chromatin modifying protein 2A |
| MspFrag108413 | 1 | 0 | CHRNB4 | cholinergic receptor, nicotinic, beta |
| MspFrag53083 | −1 | 0 | CHST12 | carbohydrate (chondroitin 4) sulfotransferase |
| MspFrag53084 | −1 | 0 | CHST12 | carbohydrate (chondroitin 4) sulfotransferase |
| MspFrag47176 | −1 | 0 | CR598133 | Casein kinase 2, beta polypeptide |
| | | | | (OTTHUMP00000062685) |
| MspFrag117641 | −1 | 0 | CR612010 | Cyclin-dependent kinase related protein |
| MspFrag94478 | −1 | 0 | CUTL2 | cut-like 2 |
| MspFrag43723 | 0 | −1 | CYFIP2 | p53 inducible protein |
| MspFrag31375 | −1 | 0 | DLG1 | discs, large homolog 1 (Drosophila) |
| MspFrag67346 | −1 | 0 | DMRT3 | doublesex and mab-3 related transcription |
| | | | | factor |
| MspFrag134765 | −1 | 0 | DNMT1 | DNA (cytosine-5-)-methyltransferase 1 |
| MspFrag18534 | −1 | 0 | DUSP2 | dual specificity phosphatase 2 |
| MspFrag45247 | −1 | 0 | DUSP22 | dual specificity phosphatase 22 |
| MspFrag11853 | −1 | 0 | DYRK3 | dual-specificity tyrosine-(Y)-phosphorylation |
| MspFrag24662 | −1 | 0 | EDEM1 | ER degradation enhancer, mannosidase |
| | | | | alpha-like |
| MspFrag136920 | 1 | 0 | EDG4 | endothelial differentiation, lysophosphatidic |
| MspFrag41049 | 1 | 0 | EDIL3 | EGF-like repeats and discoidin I-like domains 3 |
| MspFrag61819 | 1 | 0 | EFHA2 | EF hand domain family, member A2 |
| MspFrag99173 | −1 | 0 | EFNB2 | ephrin B2 |
| MspFrag138820 | 1 | 0 | EGLN2 | EGL nine (C. elegans) homolog 2 isoform 2 |
| MspFrag136016 | 1 | 0 | EPS15L1 | epidermal growth factor receptor pathway |
| MspFrag87098 | 1 | 0 | FGF19 | fibroblast growth factor 19 precursor |
| MspFrag69085 | −1 | 0 | FOXD4b | forkhead box protein D4b |
| MspFrag116828 | 1 | 0 | FOXF1 | forkhead box F1 |
| MspFrag100578 | 1 | 0 | FOXG1B | forkhead box G1B |
| MspFrag125321 | 1 | 0 | FOXJ1 | forkhead box J1 |
| MspFrag29581 | 1 | 0 | FOXL2 | forkhead box L2/Hypothetical protein |
| | | | | FLJ43329. |
| MspFrag122501 | 0 | −1 | FZD2 | frizzled 2 |
| MspFrag42857 | 1 | 0 | HBEGF | heparin-binding EGF-like growth factor |
| MspFrag10141 | 1 | 0 | HDGF | hepatoma-derived growth factor (high-mobility) |
| MspFrag139675 | 1 | 0 | HIF3A | hypoxia-inducible factor-3 alpha isoform a |
| MspFrag46589 | −1 | 0 | HIST1H3C | H3 histone family, member C/H2B histone |
| | | | | family, member F |
| MspFrag9354 | −1 | 0 | HIST2H3C | H3 histone family, member M/Histone H2B/s. |
| MspFrag47574 | −1 | 0 | HMGA1 | high mobility group AT-hook 1 isoform b |
| MspFrag17791 | −1 | 0 | HMGA1L4 | high mobility group AT-hook 1-like 4 |
| MspFrag92442 | −1 | 0 | HOXC11 | homeo box C11 |
| MspFrag82007 | −1 | 0 | HRAS | v-Ha-ras Harvey rat sarcoma viral oncogene |
| MspFrag31023 | 1 | 0 | HRASLS | HRAS-like suppressor |
| MspFrag85516 | 1 | 0 | HRASLS3 | HRAS-like suppressor 3 |
| MspFrag38798 | 0 | −1 | IRX2 | iroquois homeobox protein 2/CEI-a protein |
| | | | | precursor |
| MspFrag38676 | 0 | −1 | IRX4 | iroquois homeobox protein 4 |
| MspFrag6819 | −1 | 0 | JUN | v-jun avian sarcoma virus 17 oncogene |
| | | | | homolog |
| MspFrag136496 | −1 | 0 | JUND | jun D proto-oncogene |
| MspFrag28787 | 0 | −1 | KLF15 | Kruppel-like factor 15 |
| MspFrag70811 | −1 | 0 | KLF4 | Kruppel-like factor 4 (gut) |
| MspFrag122014 | 1 | 0 | KLHL11 | kelch-like 11 |
| MspFrag1897 | −1 | 0 | KLHL21 | kelch-like 21 (Drosophila) |
| MspFrag141540 | 1 | 0 | KLP1 | K562 cell-derived leucine-zipper-like protein 1 |
| MspFrag141543 | 1 | 0 | KLP1 | K562 cell-derived leucine-zipper-like protein 1 |
| MspFrag71516 | −1 | 0 | LHX2 | LIM homeobox protein 2 |
| MspFrag73368 | 1 | 0 | LHX3 | LIM homeobox protein 3 isoform a/isoform b |
| MspFrag7599 | −1 | 0 | LMO4 | LIM domain only 4 |
| MspFrag58527 | −1 | 0 | LRRC4 | netrin-G1 ligand |
| MspFrag116376 | −1 | 0 | MAF | v-maf musculoaponeurotic fibrosarcoma |
| | | | | oncogene |
| MspFrag102064 | −1 | 0 | MAX | MAX protein isoform e |
| MspFrag30605 | 1 | 0 | MCF2L2 | Rho family guanine-nucleotide exchange |
| | | | | factor |
| MspFrag108582 | 1 | 0 | MESDC1 | mesoderm development candidate 1 |
| MspFrag108575 | −1 | 0 | MESDC2 | mesoderm development candidate 2 |
| MspFrag127216 | 1 | 0 | METRNL | meteorin, glial cell differentiation |
| MspFrag118382 | −1 | 0 | MNT | MAX binding protein |
| MspFrag95585 | 1 | 0 | NCOR2 | nuclear receptor co-repressor 2 |
| MspFrag143622 | −1 | 0 | NKX2-2 | NK2 transcription factor related, locus 2 |
| MspFrag11208 | 0 | −1 | NMNAT2 | nicotinamide mononucleotide |
| | | | | adenylyltransferase |
| MspFrag144608 | 1 | 0 | NNAT | neuronatin isoform beta |
| MspFrag9029 | −1 | 0 | NOTCH2NL | Notch homolog 2 N-terminal like protein |
| MspFrag147637 | −1 | 0 | OLIG1 | oligodendrocyte transcription factor 1 |
| MspFrag147602 | 1 | 0 | OLIG2 | oligodendrocyte lineage transcription factor 2 |
| MspFrag106694 | 1 | 0 | ONECUT1 | one cut domain, family member 1 |
| MspFrag3120 | −1 | 0 | PAX7 | paired box gene 7 isoform 2 |
| MspFrag100936 | −1 | 0 | PAX9 | paired box gene 9 |
| MspFrag40155 | −1 | 0 | PLK2 | polo-like kinase 2 |
| MspFrag86714 | 1 | 0 | POLD4 | polymerase (DNA-directed), delta 4 |
| MspFrag94152 | −1 | 0 | POLR3B | polymerase (RNA) III (DNA directed) |
| | | | | polypeptide |
| MspFrag9042 | −1 | 0 | POLR3GL | polymerase (RNA) III (DNA directed) |
| | | | | polypeptide |
| MspFrag109916 | −1 | 0 | POLR3K | DNA directed RNA polymerase III polypeptide K |
| MspFrag10700 | −1 | 0 | POU2F1 | POU domain, class 2, transcription factor 1 |
| MspFrag19019 | 0 | −1 | POU3F3 | POU domain, class 3, transcription factor 3 |
| MspFrag6759 | −1 | 0 | PPAP2B | phosphatidic acid phosphatase type 2B |
| MspFrag16292 | −1 | 0 | PPM1B | protein phosphatase 1B isoform 1 |
| MspFrag8568 | −1 | 0 | PPM1J | protein phosphatase 1J (PP2C domain |
| | | | | containing) |
| MspFrag145985 | −1 | 0 | PPP1R3D | protein phosphatase 1, regulatory subunit 3D |
| MspFrag158744 | 1 | 0 | PPP2R3B | protein phosphatase 2, regulatory subunit B″ |
| MspFrag155565 | 1 | 0 | PRAF2 | JM4 protein |
| MspFrag155566 | 1 | 0 | PRAF2 | JM4 protein |
| MspFrag155569 | 1 | 0 | PRAF2 | JM4 protein |
| MspFrag69137 | 1 | 0 | PRKACG | protein kinase, cAMP-dependent, catalytic, |
| MspFrag123482 | −1 | 0 | PRO1855 | hypothetical protein LOC55379 |
| MspFrag78238 | −1 | 0 | PTEN | phosphatase and tensin homolog |
| MspFrag24971 | −1 | 0 | RAF1 | v-raf-1 murine leukemia viral oncogene |
| | | | | homolog |
| MspFrag25433 | 1 | 0 | RARB | retinoic acid receptor, beta isoform 2 |
| MspFrag57886 | −1 | 0 | RASA4 | RAS p21 protein activator 4 |
| MspFrag57901 | −1 | 0 | RASA4 | RAS p21 protein activator 4 |
| MspFrag105773 | 1 | 0 | RASGRP1 | RAS guanyl releasing protein 1 |
| MspFrag11846 | −1 | 0 | RASSF5 | Ras association (RalGDS/AF-6) domain family 5 |
| MspFrag107389 | −1 | 0 | SMAD6 | MAD, mothers against decapentaplegic |
| | | | | homolog 6 |
| MspFrag17134 | 1 | 0 | SPRED2 | sprouty-related protein with EVH-1 domain 2 |
| MspFrag98583 | −1 | 0 | SPRY2 | sprouty 2 |
| MspFrag106230 | −1 | 0 | TP53BP1 | tumor protein p53 binding protein, 1 |
| MspFrag115404 | 1 | 0 | TRADD | TNFRSF1A-associated via death domain |
| | | | | isoform 1 |
| MspFrag26471 | 0 | −1 | TREX1 | three prime repair exonuclease 1 isoform c |
| MspFrag91425 | −1 | 0 | YAF2 | YY1 associated factor 2 isoform a |

TABLE 2
Differentially methylated independent genomic loci having prognostic value for
assisting in diagnosing and/or monitoring estrogen receptor positive breast cancer
progression.

| | | | | | | SurvDiff |
|---|---|---|---|---|---|---|
| MspFragID | ChrNo. | FragStart | FragEnd | Fragcoef | HR | pval |
| MspFrag71255 | 9 | 117254688 | 117254878 | 1.789336515 | 5.985479873 | 0.00027500 |
| MspFrag95389 | 12 | 121990191 | 121990311 | −1.223112391 | 3.397746409 | 0.00505398 |
| MspFrag47188 | 6 | 31779150 | 31779270 | −1.48913769 | 4.433271016 | 0.00157072 |
| MspFrag112077 | 16 | 4599428 | 4599528 | 1.654936682 | 5.232748585 | 0.00312226 |
| MspFrag48154 | 6 | 41882263 | 41882369 | 1.492407942 | 4.447792662 | 0.00075956 |
| MspFrag74886 | 10 | 7493947 | 7494287 | 1.266888994 | 3.549791942 | 0.00312436 |
| MspFrag133787 | 19 | 5061798 | 5061921 | 1.510185149 | 4.527568992 | 0.00035227 |
| MspFrag10293 | 1 | 156988339 | 156988468 | −1.352767351 | 3.868115165 | 0.00125067 |
| MspFrag133520 | 19 | 4052342 | 4052489 | 2.268921401 | 9.66896625 | 0.00018425 |
| MspFrag140091 | 19 | 53516519 | 53516637 | −1.32199379 | 3.750892419 | 0.00125481 |
| MspFrag87593 | 11 | 74954448 | 74955185 | 1.34828095 | 3.85080012 | 0.00471298 |
| MspFrag73972 | 9 | 137359393 | 137359518 | −1.468333864 | 4.341994757 | 0.00061453 |
| MspFrag43335 | 5 | 142130132 | 142130242 | −1.247531492 | 3.481737643 | 0.00597369 |
| MspFrag147352 | 21 | 26028782 | 26028895 | −1.387521599 | 4.004911965 | 0.00356842 |
| MspFrag136257 | 19 | 17492812 | 17492964 | 1.451054663 | 4.267613036 | 0.00055801 |
| MspFrag12262 | 1 | 215735535 | 215735673 | −1.146568603 | 3.147374468 | 0.00573351 |
| MspFrag73693 | 9 | 137019707 | 137019817 | −1.168336249 | 3.216636502 | 0.00623659 |
| MspFrag140556 | 19 | 54872001 | 54872107 | −1.201900088 | 3.326431434 | 0.00423489 |
| MspFrag20976 | 2 | 160297718 | 160297839 | −1.321005857 | 3.747188618 | 0.00141190 |
| MspFrag104699 | 14 | 105001717 | 105001907 | 1.461284816 | 4.31149545 | 0.00190864 |
| MspFrag104698 | 14 | 105001548 | 105001716 | 1.23072722 | 3.423718428 | 0.00288209 |
| MspFrag38294 | 5 | 1058539 | 1058653 | 1.13518561 | 3.111751061 | 0.00629712 |
| MspFrag26368 | 3 | 47299112 | 47299309 | −1.223735662 | 3.399864786 | 0.00523304 |
| MspFrag19270 | 2 | 109728344 | 109728480 | −1.221590091 | 3.392577955 | 0.00397534 |
| MspFrag48771 | 6 | 55551280 | 55551756 | 1.188102922 | 3.280851269 | 0.00437394 |
| MspFrag114 | 1 | 910780 | 910944 | 1.282825291 | 3.606815648 | 0.00196387 |
| MspFrag38471 | 5 | 1397845 | 1397970 | −1.143148917 | 3.136629818 | 0.00637379 |
| MspFrag30510 | 3 | 181237336 | 181237575 | 1.16275337 | 3.198728445 | 0.00649279 |
| MspFrag133936 | 19 | 5671360 | 5671515 | −1.164519992 | 3.204384384 | 0.00512902 |
| MspFrag149398 | 22 | 17268487 | 17268601 | −1.235073737 | 3.438632066 | 0.00477843 |
| MspFrag41139 | 5 | 89861164 | 89861294 | −1.371954905 | 3.943051457 | 0.00402417 |
| MspFrag2728 | 1 | 15799045 | 15799189 | 1.495042973 | 4.459528188 | 0.00337196 |
| MspFrag10814 | 1 | 166495851 | 166495979 | −1.412974425 | 4.108156653 | 0.00063333 |
| MspFrag80476 | 10 | 124898472 | 124899105 | 1.375966697 | 3.958901932 | 0.00378052 |
| MspFrag51033 | 6 | 144206250 | 144206373 | −1.288267509 | 3.626498235 | 0.00196700 |
| MspFrag64471 | 8 | 90984320 | 90984420 | 1.235967638 | 3.441707237 | 0.00301690 |
| MspFrag22285 | 2 | 201806881 | 201806995 | −1.264100231 | 3.539906205 | 0.00380194 |
| MspFrag140565 | 19 | 54884346 | 54884467 | 1.219948156 | 3.387012133 | 0.00311352 |
| MspFrag152243 | 22 | 43725344 | 43725473 | −1.229763192 | 3.420419458 | 0.00335310 |
| MspFrag13375 | 1 | 227482368 | 227482468 | −1.272067334 | 3.568221648 | 0.00203094 |
| MspFrag44572 | 5 | 176876768 | 176876872 | −1.166177871 | 3.209701272 | 0.00504919 |
| MspFrag87619 | 11 | 75157748 | 75158526 | 1.136727722 | 3.116553432 | 0.00639376 |
| MspFrag134773 | 19 | 10202394 | 10202517 | −1.628136563 | 5.094372825 | 0.00021988 |
| MspFrag106323 | 15 | 42616766 | 42616871 | −1.168623288 | 3.217559935 | 0.00503756 |
| MspFrag30915 | 3 | 187984635 | 187984740 | −1.171251284 | 3.22602679 | 0.00485941 |
| MspFrag50671 | 6 | 133604373 | 133604569 | 1.369864049 | 3.934815717 | 0.00143865 |
| MspFrag98066 | 13 | 50381868 | 50381981 | −1.72479727 | 5.611383319 | 0.00016956 |
| MspFrag2530 | 1 | 12013668 | 12013770 | −1.6885091 | 5.411406822 | 0.00024761 |
| MspFrag122071 | 17 | 37528760 | 37528868 | 1.405634098 | 4.078111844 | 0.00111682 |
| MspFrag49533 | 6 | 97392433 | 97392781 | 1.367320628 | 3.92482054 | 0.00093517 |
| MspFrag21979 | 2 | 191010077 | 191010197 | −1.160269921 | 3.190794422 | 0.00529921 |
| MspFrag74526 | 10 | 1085534 | 1085686 | −1.379233199 | 3.971854837 | 0.00089664 |
| MspFrag24850 | 3 | 10181622 | 10181744 | 1.182484783 | 3.262470671 | 0.00461761 |
| MspFrag122497 | 17 | 39936153 | 39936299 | −1.379575285 | 3.973213786 | 0.00389536 |
| MspFrag12506 | 1 | 222376377 | 222376502 | −1.518020852 | 4.563185034 | 0.00016909 |
| MspFrag26184 | 3 | 44778202 | 44778323 | −1.385119209 | 3.995302152 | 0.00359325 |
| MspFrag106218 | 15 | 41409851 | 41409968 | −1.215646154 | 3.372472497 | 0.00349501 |
| MspFrag132799 | 19 | 2407071 | 2407181 | −1.251756515 | 3.496479185 | 0.00246759 |
| MspFrag147050 | 20 | 62186069 | 62186556 | 1.404292795 | 4.072645527 | 0.00094273 |
| MspFrag139709 | 19 | 51687603 | 51688320 | 1.343062728 | 3.830758127 | 0.00284754 |
| MspFrag124627 | 17 | 63755224 | 63755344 | −1.388270118 | 4.00791084 | 0.00193467 |
| MspFrag28146 | 3 | 102926134 | 102926245 | −1.208189601 | 3.347419 | 0.00588102 |
| MspFrag112032 | 16 | 4341395 | 4341500 | −1.366153876 | 3.920243919 | 0.00153019 |
| MspFrag134235 | 19 | 7490361 | 7490472 | 1.404691769 | 4.074270731 | 0.00114898 |
| MspFrag153212 | 22 | 49276099 | 49276807 | 1.443993969 | 4.237586854 | 0.00233113 |
| MspFrag116629 | 16 | 83875305 | 83875459 | 1.712694216 | 5.543877779 | 0.00053961 |
| MspFrag88115 | 11 | 93114508 | 93114640 | −1.637483082 | 5.142210688 | 0.00358096 |
| MspFrag8690 | 1 | 115592483 | 115592771 | 1.345947213 | 3.841823843 | 0.00098505 |
| MspFrag143626 | 20 | 21443259 | 21443362 | −1.332859385 | 3.791870318 | 0.00115807 |
| MspFrag39513 | 5 | 32746908 | 32747105 | 1.478876649 | 4.388013632 | 0.00175716 |
| MspFrag111038 | 16 | 1772863 | 1773036 | −1.219862932 | 3.38672349 | 0.00421415 |
| MspFrag75103 | 10 | 12278200 | 12278346 | −1.304058235 | 3.684217792 | 0.00163693 |
| MspFrag147603 | 21 | 33319190 | 33319410 | 2.132782161 | 8.438310923 | 0.00061526 |
| MspFrag119967 | 17 | 17435790 | 17435909 | −1.165538567 | 3.207649953 | 0.00552926 |
| MspFrag57600 | 7 | 99948509 | 99948693 | −1.303253284 | 3.68125337 | 0.00161006 |
| MspFrag62663 | 8 | 30789308 | 30789516 | −1.384780038 | 3.993947292 | 0.00352456 |
| MspFrag153532 | 23 | 317656 | 318018 | −1.160101357 | 3.190256615 | 0.00516916 |
| MspFrag124509 | 17 | 61730005 | 61730435 | 1.332410524 | 3.790168677 | 0.00379466 |
| MspFrag889 | 1 | 2012874 | 2013549 | 1.478691717 | 4.387202223 | 0.00368453 |
| MspFrag133895 | 19 | 5631905 | 5632028 | −1.675908095 | 5.343645484 | 0.00263692 |
| MspFrag65259 | 8 | 117955703 | 117955819 | −1.256149949 | 3.51187453 | 0.00405783 |
| MspFrag151765 | 22 | 40006076 | 40006184 | −1.277133336 | 3.586344132 | 0.00330188 |
| MspFrag93077 | 12 | 63290673 | 63290780 | −1.313621499 | 3.71961995 | 0.00147845 |
| MspFrag154217 | 23 | 16648822 | 16648956 | −1.73436197 | 5.665312011 | 0.00179580 |
| MspFrag30933 | 3 | 188340053 | 188340359 | −1.181728132 | 3.260003053 | 0.00440769 |
| MspFrag67172 | 8 | 145988480 | 145988611 | −1.34207545 | 3.82697797 | 0.00496420 |
| MspFrag108680 | 15 | 80611418 | 80611557 | −1.190467122 | 3.288617034 | 0.00399692 |
| MspFrag48529 | 6 | 45498824 | 45499059 | 1.353693437 | 3.871699032 | 0.00274824 |
| MspFrag78915 | 10 | 102096648 | 102096805 | −1.401768152 | 4.06237652 | 0.00313356 |
| MspFrag45048 | 5 | 179951412 | 179951584 | 1.445944433 | 4.24586018 | 0.00475831 |
| MspFrag23268 | 2 | 228871474 | 228871638 | 1.371475464 | 3.941161449 | 0.00386492 |
| MspFrag82220 | 11 | 790629 | 790745 | 1.178908888 | 3.250825253 | 0.00566770 |
| MspFrag121945 | 17 | 36057891 | 36058069 | −1.435589651 | 4.202122064 | 0.00041925 |
| MspFrag55064 | 7 | 37990925 | 37991098 | −1.316549588 | 3.730527289 | 0.00138406 |
| MspFrag141396 | 19 | 60382900 | 60383323 | 1.358854589 | 3.891733114 | 0.00121286 |
| MspFrag115628 | 16 | 66433452 | 66433557 | −1.397913512 | 4.046747662 | 0.00064213 |
| MspFrag134460 | 19 | 7914772 | 7914883 | −1.234426603 | 3.43640753 | 0.00303999 |
| MspFrag107677 | 15 | 68177226 | 68177342 | −1.275500148 | 3.580491738 | 0.00206491 |
| MspFrag12418 | 1 | 220340859 | 220340980 | −1.276041304 | 3.582429867 | 0.00202705 |
| MspFrag17763 | 2 | 74557123 | 74557302 | 2.014147178 | 7.494333323 | 0.00147787 |
| MspFrag12730 | 1 | 224501836 | 224502025 | 1.336415404 | 3.805378284 | 0.00124251 |
| MspFrag6493 | 1 | 52730331 | 52730552 | 1.134235264 | 3.108795226 | 0.00636216 |
| MspFrag127563 | 18 | 5286616 | 5286772 | −1.180285793 | 3.255304413 | 0.00600635 |
| MspFrag137582 | 19 | 39860359 | 39860494 | −1.270370269 | 3.56217128 | 0.00228207 |
| MspFrag133861 | 19 | 5406519 | 5406637 | 1.702156815 | 5.485766425 | 0.00219132 |

| MspFragID | GeneSymbol | GeneAnnotation |
|---|---|---|
| MspFrag71255 | AB014534 | Astrotactin 2 |
| MspFrag95389 | AB040953/BC015569 | Hypothetical protein FLJ90257/ARL6IP4 protein |
| MspFrag47188 | AF195764/BAT5 | Megakaryocyte-enhanced gene transcript 1 |
| | | protein/HLA-B associated transcript 5 |
| MspFrag112077 | AF447881 | Hypothetical protein PP11303 |
| MspFrag48154 | AJ586139 | Ubiquitin carboxyl-terminal hydrolase 49 (EC 3.1.2.15) |
| | | (Ubiquitin thiolesterase 49) |
| MspFrag74886 | AK090887 | Scm-like with four mbt domains 2 |
| MspFrag133787 | AK093006 | Hypothetical protein FLJ35687 |
| MspFrag10293 | AK095879 | Phosphoprotein enriched in astrocytes 15 |
| MspFrag133520 | AK126446 | Hypothetical protein FLJ26075 |
| MspFrag140091 | AK128144/EMP3 | Hypothetical protein FLJ46265./epithelial membrane |
| | | protein 3 |
| MspFrag87593 | AK131503 | Hypothetical protein FLJ16712. |
| MspFrag73972 | ANAPC2/SSNA1 | anaphase-promoting complex subunit 2/nuclear |
| | | autoantigen of 14 kDa |
| MspFrag43335 | ARHGAP26 | Rho GTPase activating protein 26 |
| MspFrag147352 | ATP5J/GABPA | ATP synthase, H+ transporting, mitochondrial F0/GA |
| | | binding protein transcription factor, alpha |
| MspFrag136257 | AY254197 | B-cell novel protein isoform 1. |
| MspFrag12262 | AY341430 | Lysophospholipase-like 1 |
| MspFrag73693 | AY358419/PHPT1 | OTTHUMP00000022621./phosphohistidine |
| | | phosphatase 1 |
| MspFrag140556 | AY775289 | Protein arginine methyltransferase 1 isoform 4. |
| MspFrag20976 | BAZ2B | bromodomain adjacent to zinc finger domain, 2B |
| MspFrag104699 | BC006177 | MTA1 protein. |
| MspFrag104698 | BC006177 | MTA1 protein. |
| MspFrag38294 | BC012176 | NKD2 protein. |
| MspFrag26368 | BC015311/AK023765 | KIF9 protein./Hypothetical protein FLJ13703./KIF9 |
| | | protein. |
| MspFrag19270 | BC020502/C2orf26 | Hypothetical protein FLJ12620./hypothetical protein |
| | | LOC65124 |
| MspFrag48771 | BC024194 | OTTHUMP00000016647. |
| MspFrag114 | BC024295 | SAMD11 protein. |
| MspFrag38471 | BC025305 | Cisplatin resistance related protein CRR9p. |
| MspFrag30510 | BC036183/BC036183 | Splice isoform 3 of Q8IYB4/Splice isoform 3 of Q8IYB4 |
| MspFrag133936 | BC043005/PRSS15 | MGC39581 protein./protease, serine, 15 |
| MspFrag149398 | BC047039 | DGCR6 protein (Fragment). |
| MspFrag41139 | BC058027 | Hypothetical protein DKFZp686F0735. |
| MspFrag2728 | BC068599 | PLEKHM2 protein. |
| MspFrag10814 | BC091516/MGC9084 | Hypothetical protein FLJ13470/hypothetical protein |
| | | MGC9084 |
| MspFrag80476 | BUB3 | BUB3 budding uninhibited by benzimidazoles 3 |
| MspFrag51033 | C6orf93 | hypothetical protein LOC84946 |
| MspFrag64471 | C8orf1 | hypothetical protein LOC734 |
| MspFrag22285 | CFLAR | CASP8 and FADD-like apoptosis regulator |
| MspFrag140565 | CPT1C | carnitine palmitoyltransferase 1C |
| MspFrag152243 | CR456448 | OTTHUMP00000028969. |
| MspFrag13375 | CR598847 | Hypothetical gene supported by BC009447 (Novel |
| | | protein). |
| MspFrag44572 | DDX41 | DEAD-box protein abstrakt |
| MspFrag87619 | DGAT2 | diacylglycerol O-acyltransferase homolog 2 |
| MspFrag134773 | EDG5 | endothelial differentiation, sphingolipid |
| MspFrag106323 | EIF3S1 | eukaryotic translation initiation factor 3, subunit 1 |
| | | alpha, 35 kDa |
| MspFrag30915 | EIF4A2 | eukaryotic translation initiation factor 4A, |
| MspFrag50671 | EYA4 | eyes absent homolog 4 (Drosophila) |
| MspFrag98066 | FLJ11712/FLJ11712 | hypothetical protein LOC79621/hypothetical protein |
| | | LOC79621 |
| MspFrag2530 | FLJ12438 | IGFBP-2-Binding Protein, IIp45 |
| MspFrag122071 | GCN5L2/HSPB9 | GCN5 general control of amino-acid synthesis 5-like 2 |
| | | (yeast)/heat shock protein, alpha-crystallin-related, |
| MspFrag49533 | GPR63 | G protein-coupled receptor 63 |
| MspFrag21979 | HIBCH | 3-hydroxyisobutyryl-Coenzyme A hydrolase isoform |
| MspFrag74526 | IDI1 | isopentenyl-diphosphate delta isomerase |
| MspFrag24850 | IRAK2 | interleukin-1 receptor-associated kinase 2 |
| MspFrag122497 | KIAA0553 | hypothetical protein LOC23131 |
| MspFrag12506 | KIAA0792 | hypothetical protein LOC9725 |
| MspFrag26184 | KIF15/BC008468 | kinesin family member 15/KIAA1143 protein./kinesin |
| | | family member 15 |
| MspFrag106218 | LCMT2/FLJ44620 | leucine carboxyl methyltransferase 2/hypothetical |
| | | protein LOC161823 |
| MspFrag132799 | LMNB2 | lamin B2 |
| MspFrag147050 | LOC198437 | hypothetical protein LOC198437 |
| MspFrag139709 | LOC400707 | hypothetical protein LOC400707 |
| MspFrag124627 | LOC51321 | hypothetical protein LOC51321 |
| MspFrag28146 | LRRIQ2 | leucine-rich repeats and IQ motif containing 2 |
| MspFrag112032 | Magmas | mitochondria-associated granulocyte macrophage |
| MspFrag134235 | MCOLN1 | mucolipin 1 |
| MspFrag153212 | MGC16635 | hypothetical protein LOC113730 |
| MspFrag116629 | MGC22001 | hypothetical protein LOC197196 |
| MspFrag88115 | MGC5306/AL136605 | hypothetical protein MGC5306/PTD012. |
| MspFrag8690 | NGFB/AK172772 | nerve growth factor, beta polypeptide/Hypothetical |
| | | protein FLJ23933. |
| MspFrag143626 | NKX2-2 | NK2 transcription factor related, locus 2 |
| MspFrag39513 | NPR3 | natriuretic peptide receptor C/guanylate cyclase C |
| | | (atrionatriuretic peptide receptor C) |
| MspFrag111038 | NUBP2/SSB3 | nucleotide binding protein 2 (MinD homolog, E)/SPRY |
| | | domain-containing SOCS box protein SSB-3 |
| MspFrag75103 | NUDT5/C10orf7 | nudix-type motif 5/chromosome 10 open reading frame 7 |
| MspFrag147603 | OLIG2 | oligodendrocyte lineage transcription factor 2 |
| MspFrag119967 | PEMT | phosphatidylethanolamine N-methyltransferase |
| MspFrag57600 | POP7 | processing of precursor 7, ribonuclease P |
| MspFrag62663 | PPP2CB | protein phosphatase 2, catalytic subunit, beta |
| MspFrag153532 | PPP2R3B | protein phosphatase 2, regulatory subunit B″ |
| MspFrag124509 | PRKCA | protein kinase C, alpha |
| MspFrag889 | PRKCZ | protein kinase C, zeta |
| MspFrag133895 | QIL1/AY313896 | hypothetical protein LOC125988/Short-chain |
| | | dehydrogenase/reductase 10 g |
| MspFrag65259 | RAD21 | RAD21 homolog |
| MspFrag151765 | RANGAP1 | Ran GTPase activating protein 1 |
| MspFrag93077 | RASSF3 | Ras association (RaIGDS/AF-6) domain family 3 |
| MspFrag154217 | RBBP7 | retinoblastoma binding protein 7 |
| MspFrag30933 | RPL39L | ribosomal protein L39-like protein |
| MspFrag67172 | RPL8 | ribosomal protein L8 |
| MspFrag108680 | RPS17 | ribosomal protein S17 |
| MspFrag48529 | RUNX2 | runt-related transcription factor 2 isoform a |
| MspFrag78915 | SCD | stearoyl-CoA desaturase |
| MspFrag45048 | SCGB3A1 | secretoglobin, family 3A, member 1 |
| MspFrag23268 | SKIP | sphingosine kinase type 1-interacting protein |
| MspFrag82220 | SLC25A22 | mitochondrial glutamate carrier 1 |
| MspFrag121945 | SMARCE1 | SWI/SNF-related matrix-associated |
| MspFrag55064 | STARD3NL | MLN64 N-terminal homolog |
| MspFrag141396 | SYT5 | synaptotagmin V |
| MspFrag115628 | THAP11 | THAP domain containing 11 |
| MspFrag134460 | TIMM44 | translocase of inner mitochondrial membrane 44 |
| MspFrag107677 | TLE3 | transducin-like enhancer of split 3 (E(sp1) homolog, |
| | | Drosophila) |
| MspFrag12418 | TP53BP2 | tumor protein p53 binding protein, 2 |
| MspFrag17763 | WDR54 | WD repeat domain 54 |
| MspFrag12730 | WNT3A | wingless-type MMTV integration site family, |
| MspFrag6493 | ZCCHC11 | zinc finger, CCHC domain containing 11 |
| MspFrag127563 | ZFP161 | zinc finger protein 161 homolog |
| MspFrag137582 | ZNF302 | zinc finger protein 302/zinc finger protein 302 |
| MspFrag133861 | ZNRF4 | zinc and ring finger 4 |

1. Method for assisting in diagnosing breast cancer and/or monitoring breast cancer progression, comprising:
(a) determining a methylation state at one or more genomic loci of the DNA comprised in a given sample to be analyzed;
(b) identifying one or more genomic loci exhibiting differences in its/their DNA methylation state;
(c) performing a statistical survival analysis for each of the one or more differentially methylated genomic loci obtained in step (b);
(d) determining a statistical significance of the data obtained in step (c); and
(e) selecting one or more genomic loci displaying statistically significant differences in its/their DNA methylation state based on the data obtained in step (d), wherein the one or more genomic loci selected have prognostic value for assisting in diagnosing breast cancer and/or monitoring breast cancer progression.

2. The method of claim 1, wherein the breast cancer is estrogen receptor positive breast cancer.

3. The method of claim 1 for assisting in diagnosing breast cancer and/or monitoring breast cancer progression in a patient, further comprising:
providing a genomic DNA sample from the patient to be analyzed,
wherein the method is performed in vitro.

4. The method of claim 1, further comprising:
classifying the one or more genomic loci according to its/their methylation state as unmethylated, partially methylated, and methylated prior to performing step (c).

5. The method of claim 1, wherein the statistical survival analysis performed in step (c) comprises generating Kaplan-Meier survival estimates for the respective methylation states of each of the one or more genomic loci and calculating the differences between the Kaplan-Meier survival estimates generated for each of the loci.

6. The method of claim 1, wherein determining the statistical significance of the data obtained in the survival analysis comprises applying the log-rank or Mantel-Haenszel test.

7. The method of claim 6, wherein determining the statistical significance further comprises a permutation testing method.

8. The method of claim 1, further comprising:
determining whether the prognostic value of the one or more genetic loci selected is independent of other pathological parameters than the methylation state.

9. The method of claim 1, wherein the method is performed using a computing device.

10. Panel of genetic markers for assisting in diagnosing breast cancer and/or monitoring breast cancer progression in a patient, wherein the panel comprises any one or more, combination thereof, or all, of the genetic markers listed in Table 1.

11. Panel of genetic markers for assisting in diagnosing estrogen receptor positive breast cancer and/or monitoring estrogen receptor positive breast cancer progression in a patient, wherein the panel comprises any one or more, preferably combination thereof, or all, of the genetic markers listed in Table 2.

12. The panel of genetic markers of claim 10 or 11, wherein the panel is determined by the method as defined in any of claims 1 to 9.

13. (canceled)

14. The panel of claim 10, wherein monitoring breast cancer progression comprises stratification of breast cancer patients into good or poor prognosis groups.

15. The panel of claim 10, wherein monitoring breast cancer progression comprises predicting relapse free survival at five years from diagnosis.
